(19) United States
(12) Patent Application Publication
(10) Pub. No.: US 2002/0143653 A1
(43) Pub. Date: Oct. 3, 2002

(54) Configuration system and methods

(76) Inventors: Ettore DiLena, Somerville, MA (US); Kris Dockx, Rillaar (BE); Yvan DeBoeck, Somerville, MA (US); Duncan N. McGillivray, Brighton, MA (US)

Correspondence Address: Daryl C. Josephson, Esq., Squire, Sanders & Dempsey L.L.P., 600 Hansen Way, Palo Alto, CA, 94304, US

(21) Appl. No.: 10/036,974

(22) Filed: Dec. 29, 2001

Related U.S. Application Data
(60) Provisional application No. 60/259,070, filed on Dec. 28, 2000.
(60) Provisional application No. 60/295,462, filed on May 31, 2001.

(51) Int. Cl. G06F 17/60

(52) U.S. Cl. 705/26

(57) ABSTRACT

Aspects of the invention provide for creating, operating and updating product configurators. A configuration creation embodiment includes receiving data corresponding to product or service options, identifying a solution space corresponding to the data, setting rules for evaluating constraint relationships of the data and for navigating the solution space, and generating cross-domain logical response engines corresponding to a navigation of the solution space.

### PRIORITY REFERENCE TO RELATED APPLICATIONS

This application claims benefit of and hereby incorporates by reference provisional application serial No. 60/259,070, entitled “Product Configuration Manager,” filed on Dec. 28, 2000 by inventor Ettore DiLena and provisional application serial No. 60/295,462, entitled “Distributed Artificial Intelligent Agent Network,” filed on May 31, 2001 by inventors Claudia Betz-Haubold, Rohit Bhargava, Yvan DeBoeck, Ettore Dilena, Chris Docky, Claudia Schmid and Guenther Moeckesch. This application also hereby incorporates by reference provisional application Ser. No. 09/152,494, entitled “Method and Apparatus for Business Modeling,” filed on Sep. 13, 1998 by inventors Anja Behrmann, et al.

### BACKGROUND OF THE INVENTION

1. Field of the Invention

This invention relates generally to computer systems, and more particularly provides a system and methods for creating and utilizing a product/service configurator.

2. Description of the Background Art

Today's product offerings include not only standard products, but also products that a product customer can customize to some extent. Such product customizations that are selectable by a product end-customer or “consumer” are more commonly referred to as product configurations.

Recently, product suppliers have attempted to replace earlier pen-and-paper product-option forms with integrated computer programs or “product configurators.” Such product configurators are essentially custom point-of-sale programs for enabling consumers to select from among options made available with respect to a desired product by the product seller (i.e. manufacturer or retail sales).

As with paper forms, a product configurator receives and records consumer selections. Additionally, since not all consumer selections might be allowable (e.g. 2 car stereos), a configurator might also include sufficient manufacturing information to check whether the supplier generally allows such a configuration. Selectable options are generally limited at present to finishing or module alternatives that do not substantially affect manufacturing (e.g. selecting a car radio upgrade). If the resulting product configuration is found to be allowable, then the product configurator might further provide features such as displaying pricing, printing or storing the configuration, or perhaps generating a purchase order.

Unfortunately, providing even such limited functionality can be tedious and expensive, and product configurators can be large and complex. One reason is that products, product models and product model options from even the same manufacturer can vary considerably. Information from which allowable options can be determined must also often be obtained from various sources. Thus, each product model may well utilize a uniquely programmed product configurator. Including product manufacturing, pricing and other information within each product configurator (where such features are provided) can also cause the resulting product configurators to become unwieldy.

Among other difficulties are problems arising from the programming techniques used by suppliers. It is observed, for example, the use of custom programming increases the chances that configurable options and manufacturing and other information will include errors or require updating, and further, that the task of updating or further utilizing such information will be rendered more difficult. While modernly popular techniques such as object oriented programming or “OOP” provide benefits such as encapsulation, inheritance and delegation, actual implementations currently tend to mimic the complex integration of procedural programming. Thus, even with such capabilities, each product configurator may well include unique peculiarities and require considerable effort, should the programming or included product or other information require updating.

In view of these and other difficulties, it is not clear that creating and maintaining product configurators can be justified, particularly in view of their limited utility.

Accordingly, there is a need for systems and methods that enable product configurators to more readily created. There is also a need for systems and methods that enable product configurators to provide up-to-date information. There is also a need for more capable product configurators and systems capable of exploiting them, thereby rendering product configuration efforts more useful.

### SUMMARY OF THE INVENTION

Aspects of the invention provide for more readily creating, effectively utilizing and reliably updating more capable and efficient product configurators. In one aspect, a product configuration system provides for forming a product configurator in a reusable manner applicable to varying product/service utilizations (e.g. products, components, processing, programming, servicing, outsourcing, etc.). A further aspect provides for configurator and other interfaces useable, to varying ends, by customers, employees, suppliers etc. Another aspect enables interface navigation and/or other configuration information to be efficiently utilized in conjunction with other systems or system components, among still further aspects.

A configuration method embodiment according to the invention includes receiving data corresponding to product or service options, identifying a solution space corresponding to the data, setting rules for evaluating constraint relationships of the data and for navigating the solution space, and generating cross-domain logical response engines corresponding to a navigation of the solution space. The solution space can, for example, correspond to an organization of product information for supporting allowable product/service configurations. The logic engines can, for example, enable configurator navigation and/or efficient pre, intra and/or post configuration access to other systems.

A further configuration method embodiment includes receiving one or more product configuration options, determining a logical relationship to further configuration options, and providing an indicator corresponding to the further configuration options. The indicator can, for example, provide configurator and/or extra-configurator navigation.

A still further configuration method embodiment includes receiving product (or service) information from a user corresponding to an actual or potential product purchase, determining an indicator corresponding to the product (or service) information, causing the indicators to be provided to a supply system, receiving supply information from the supply system, and using the indicator and supply system information to provide product/service options to the user. Such method can, for example, enable interactive automatic (or remotely assisted) checking whether corresponding local or remote inventories exist, and if not, whether/when desired options can be manufactured (e.g. component, process, alternatives and/or worker availability); delivery options or constraints in accordance therewith can further be determined and supplied to the user. Such method further enables pricing, purchasing, credit, user status or other pertinent information to be similarly determined and/or system testing or updating to be performed, among other examples.

Advantageously, aspects of the invention enable product configurators to be created in a reusable manner that further facilitates automating at least portions of such creation. Aspects further enable the size and complexity of product configurators to be significantly reduced, while enabling configurator inter-operability, portability and ease-of-updating to be substantially increased. Aspects further enable robust distributed-system collaboration, such that product configurator operation can be made more flexible and useful for product/service configuration, updating and other uses. Other advantages will also become apparent by reference to the following text and figures.

### BRIEF DESCRIPTION OF THE DRAWINGS

FIG. 1 is a flow diagram illustrating a configuration system according to an embodiment of the invention;

FIG. 2 is a flow diagram illustrating another configuration system according to an embodiment of the invention;

FIG. 3a is a block diagram illustrating a processing system capable of implementing configuration system elements, according to an embodiment of the invention;

FIG. 3b illustrates, in greater detail, how working memory of the processing system of FIG. 3 can include a browser;

FIG. 3c illustrates, in greater detail, how working memory of the processing system of FIG. 3 can include a configuration manager;

FIG. 3d illustrates, in greater detail, how working memory of the processing system of FIG. 3 can include supplier systems;

FIG. 4 is a flow diagram illustrating a configuration manager according to an embodiment of the invention;

FIG. 5a is a block diagram illustrating the configuration creator of FIG. 3 in greater detail;

FIG. 5b is a block diagram illustrating the configurators of FIG. 3 in greater detail;

FIG. 5c is a block diagram illustrating the preference engine of FIG. 3 in greater detail;

FIG. 5d is a block diagram illustrating the update engine of FIG. 3 in greater detail;

FIG. 5e is a block diagram illustrating the linker of FIG. 3 in greater detail;

FIG. 6 is a flow diagram illustrating a further configurator according to an embodiment of the invention;

FIG. 7 is a flow diagram illustrating a characteristic value expression portion of the configurator of FIG. 6 in greater detail;

FIG. 8 is a flow diagram illustrating a characteristic value inclusion portion of the configurator of FIG. 6 in greater detail;

FIG. 9 is a flow diagram illustrating a product component portion of the configurator of FIG. 6 in greater detail;

FIG. 10 is a flow diagram illustrating a product function portion of the configurator of FIG. 6 in greater detail;

FIG. 11 is a flow diagram illustrating a product item solution portion of the configurator of FIG. 6 in greater detail;

FIG. 12 is a flow diagram illustrating a configuration portion of the configurator of FIG. 6 in greater detail;

FIG. 13 is a screenshot illustrating a selection operation of a configuration manager user interface (CMUI) according to an embodiment of the invention;

FIG. 14 is a flow diagram illustrating a configuration model configured to provide the operation of FIG. 13, according to an embodiment of the invention;

FIG. 15 is a screenshot illustrating a further selection operation of a configuration manager user interface according to an embodiment of the invention;

FIG. 16 is a flow diagram illustrating a configuration model configured to provide the operation of FIG. 15 according to an embodiment of the invention;

FIG. 17 is a screenshot illustrating a further selection operation of a configuration manager user interface according to an embodiment of the invention;

FIG. 18 is a flow diagram illustrating a configuration model configured to provide a portion of the operation of FIG. 17 according to an embodiment of the invention;

FIG. 19 is a flow diagram illustrating a configuration model configured to provide a further portion of the operation of FIG. 17 according to an embodiment of the invention;

FIG. 20 is a flow diagram illustrating a supply chain network implementation according to an embodiment of the invention;

FIG. 21 is a flow diagram illustrating a further supply chain network implementation according to an embodiment of the invention;

FIG. 22 is a flow diagram illustrating an agent network example capable of implementing a configuration system according to an embodiment of the invention; and

FIG. 23 is a flow diagram illustrating an agent network example implementing a configuration system according to an embodiment of the invention.

### DETAILED DESCRIPTION

In providing for configuration systems and methods, aspects of the invention enable product, service, processing and other “product” configuration to be implemented in a more flexible, reusable and effective manner that can facilitate automatic (e.g. programmatic) and/or user assisted creation, operation and maintenance. Aspects further enable configuration to be conducted in conjunction with varying products, services, processes and/or components thereof, and further, of operating alone or in conjunction with other locally and/or remotely located intra and/or inter-entity systems, among still further aspects.

Note that the term “or”, as used herein, is intended to generally mean “and/or”, unless otherwise indicated. Additionally, references made herein to particular “Skyva” implementations as well as directional arrows in the accompanying drawings are provided so that various aspects of the invention might be better understood. References to “products,” “product configuration system,” “product configurator,” “product supplier systems” and the like can further generally include one or more products, services, processing, and the like, components thereof or some combination, unless otherwise indicated. Such references are exemplary and should not be construed as limiting.

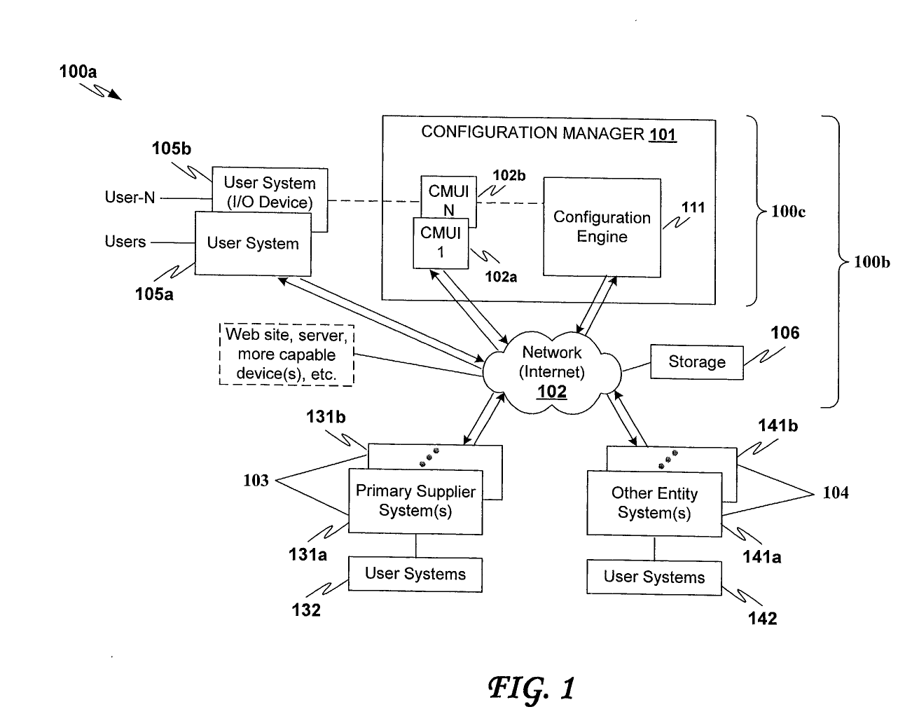

Turning now to FIG. 1, embodiments of the invention provide a high degree of flexibility with regard to product configuration, configurator creation, operation and maintenance, and various manners of implementing configuration alone or in conjunction with other systems. However, while such flexibility is useful, the nature of particular system elements can become confusing. For example, on the one hand, configuration element embodiments can operate alone or in conjunction with highly integrated to highly distributed systems of one or more supply chain entities (“supplier systems”) and/or users, such that the configuration elements are or appear to be “hosted” by the one or more such systems. Conversely, configuration element embodiments are also capable of interoperating with widely varying supplier system types, such that the supplier system elements appear to be configuration system elements for configuration purposes.

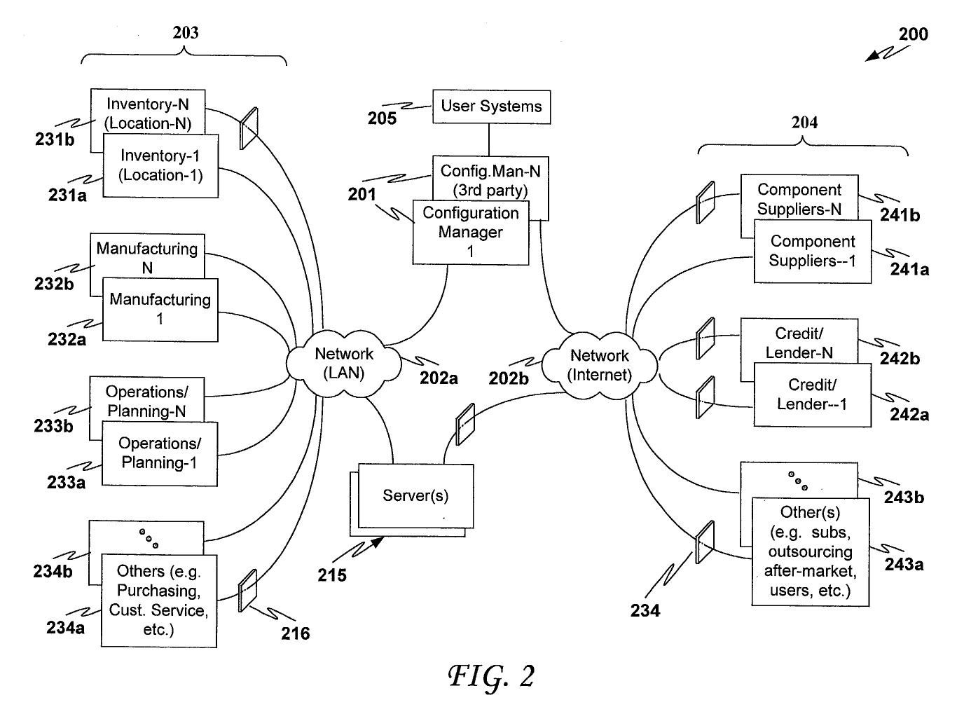

Therefore, the discussion will first consider various system implementation examples with reference to FIGS. 1 and 2, before continuing with suitable processing systems and then configuration system and method details. Also, for greater clarity, a system of one or more configuration elements will be referred to hereinafter as a “configuration manager”, while a system that includes configuration manager elements as well as elements of other systems that are capable of being utilized in conjunction with configuration manager elements will be referred to collectively as a “configuration system”.

Configuration system 100a of FIG. 1, for example, provides a distributed configuration system embodiment that might be utilized within one or more products, across various entities of a supply chain, or for other local/remote user access, among other uses. Configuration system 100a includes at least one configuration manager 101, a wired or wirelessly couplable network 102 (e.g. a wide area network or “WAN”, such as the Internet), inter-entity product supplier systems 103 and 104, and one or more remote user systems 105a. Configuration manager 101 further includes configuration engines 111 and configuration manager user interfaces or “CMUIs” 1 through N 112a, 112b. Finally, inter-entity product supplier systems 103 and 104 include primary supplier systems 131a, 131b and other-entity systems 141a, 141b which other-entity systems 141a, 141b can also include user systems (e.g. systems 142).

Configuration engines 111 provide a configuration “back end” for conducting operations that are more specifically configuration-related, such as performing configurator creation, operation, updating, and the like. CMUIs 112a and 112b provide one or more textural, graphic, combined or other so-called “multimedia” user interfaces for enabling user interaction with configuration engine elements and, via the configuration engines, for conducting configuration operations that utilize inter-entity systems 103 and 104.

Configuration system 100b of FIG. 1 provides a less distributed system embodiment that might, for example, be used in conjunction with a kiosk, support center, consumer system, and so on, that are typically connectable to an external resource. External resources might include a supplier web site, other wired or wirelessly couplable remote data stores (e.g. 106) or more capable processing systems (e.g. a PC, server) than a lesser capable user device (e.g. smart phone, personal information manager or “PIM”, etc.), among other examples.

A more integrated configuration system can also be implemented to include, for example, a configuration manager 101 or elements thereof, and at least one user system, such as input/output (“I/O”) device 105a or a suitable processing system. Such an implementation might be utilized in a point-of-sale terminal or as a loadable, downloadable or hardware processing system component (e.g. personal computer, handheld, etc.), among other examples.

Embodiments of the invention also enable combinations of the above or other implementations to be provided. For example, configurator creation, operation and maintenance might utilize different configuration manager elements or enable or limit interoperation with or access to particular supplier systems or system elements. User access location, user/group status or other considerations can also be used to provide various separate or combined configuration system or configuration manager implementations of similar or varying types, among other examples.

In FIG. 2, for example, a combined configuration system implementation 200 is illustrated. (For convenience, numbering of FIG. 2 elements that correspond with those of FIG. 1 are also correspondingly numbered.) Configuration system 200 includes configuration managers 201a and 201b, a local area network or “LAN” 202a, a WAN 202b (such as the Internet), and inter-entity systems, which further include primary supplier systems 203 and other-entity systems 204. Primary supplier systems 203 can include a variety of supplier systems, such as inventory systems 231a, 231b, manufacturing systems 232a, 232b, operations/planning systems 233a, 233b, and other systems 234a, 234b, such as purchasing, customer service, and so on. Primary supplier systems 203 can further include network servers 215 and one or more protection systems, which can include firewalls 216 or other security.

Other entity systems 204 can also include various systems, such as those of component suppliers 241a, 241b, credit services 242a, 242b, and other systems 243 (e.g. for outsourcing services, other sub-contractors, after-market suppliers, their customer systems, and so on). Other entity systems 204 can also include network servers (not shown), firewalls 234, etc, as well as systems such as the above primary supplier system examples for conducting their own business operations. Other entity systems 204 can also include configuration manager elements, such as those already discussed, for providing configuration with regard to such other entities.

As with the systems of FIG. 1, configuration managers 101, 201 can be utilized for different products having different configurable options. Configuration managers 101, 201 can also be rendered accessible by at least primary supplier systems 203 users via suitable user systems (which, for greater clarity, are not shown), and can further be used by users primary supplier systems for different purposes. For example, primary supplier systems 203 users can participate in product configurator creation or maintenance, or can utilize product configuration information in unique manners (see below). Customer users can further be allowed access to configuration systems 201 for product configuration (via user systems 205), but disallowed access for configurator creation, modification or maintenance, and in different manners, including those already discussed with reference to FIG. 1.

It will further be appreciated that each inter-entity system may be effectuated in a different manner, or alternatively stated, in a different operating “domain” from other inter-entity system or from configurator systems 201. For example, inventory can and is typically conducted in a different manner (utilizing different data and data structures) than manufacturing. An inventory system of one supplier or group, management level or location of the same supplier (e.g. 231a) can also be conducted differently and thus have a different operational domain than an inventory system of a different supplier or even a different group, management level or location of the same supplier (e.g. 231b). Configuration manager 101, 201 implementations according to the invention are nevertheless capable of interoperating with systems having such different domains.

Note also that primary supplier system users (e.g. manufacturers, sellers, contractors, and so on) might also be customers with regard to other entity suppliers (e.g. component suppliers, manufacturers, sub-contractors/outsourcing services, backup sources, and so on). Configuration manager 201 embodiments also enable interoperability with other entity supplier systems, or further with improved security, to provide additional configuration system utility to customers or primary supplier system users (in this case, “secondary customers”) or other classifications of users, and so on through various relationships within product, service or other supply chains.

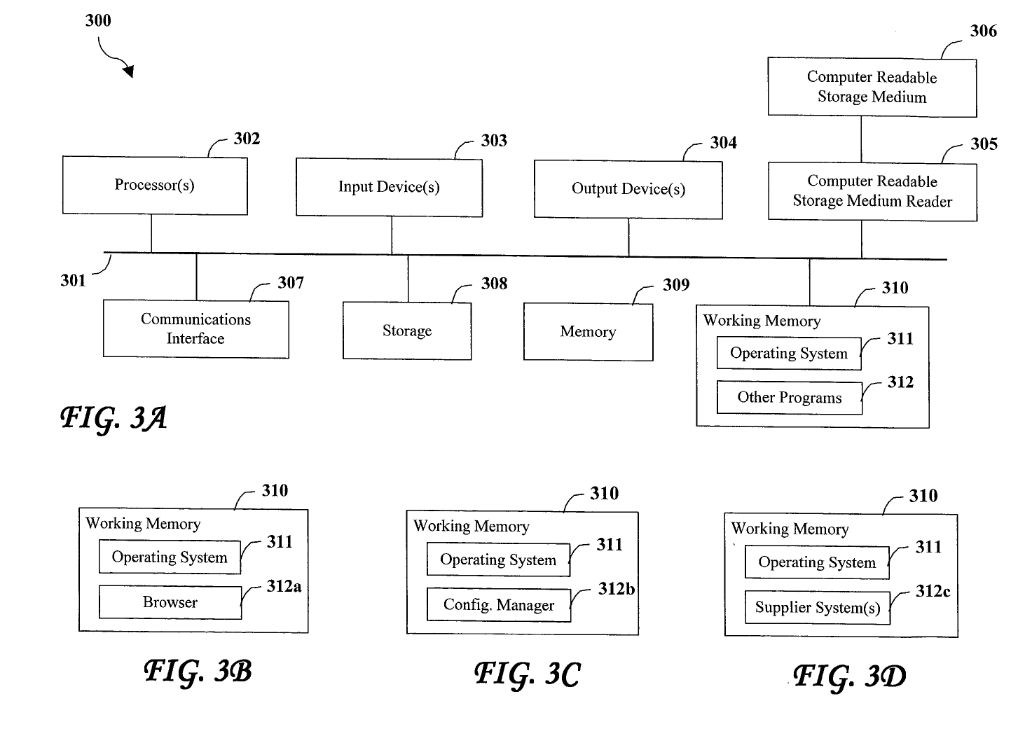

Turning now to FIG. 3a, an exemplary processing system is illustrated that can comprise one or more of the elements of FIGS. 1 and 2. While other alternatives might be utilized, it will be presumed for clarity sake that elements of the systems of FIGS. 1 and 2 are implemented in hardware, software or some combination by one or more processing systems consistent therewith, unless otherwise indicated.

Processing system 300 comprises elements coupled via communication channels (e.g. bus 301) including one or more general or special purpose processors 302, such as a Pentium® or Power PC®, digital signal processor (“DSP”), etc. System 300 elements also include one or more input devices 303 (such as a mouse, keyboard, microphone, pen, etc.), and one or more output devices 304, such as a suitable display, speakers, actuators, etc., in accordance with a particular application.

System 300 also includes a computer readable storage media reader 305 coupled to a computer readable storage medium 306, such as a storage/memory device or hard or removable storage/memory media; such devices or media are further indicated separately as storage device 308 and memory 309, which can include hard disk variants, floppy/compact disk variants, digital versatile disk (“DVD”) variants, smart cards, read only memory, random access memory, cache memory, etc., in accordance with a particular application. One or more suitable communication devices 307 can also be included, such as a modem, DSL, infrared or other suitable transceiver, etc. for providing inter-device communication directly or via one or more suitable private or public networks that can include but are not limited to those already discussed.

Working memory 310 (e.g. of memory 309) further includes operating system (“OS”) 311 elements and other programs 312, such as application programs, mobile code, data, etc. for implementing system 100a-c/200 elements that might be stored or loaded therein during use. The particular OS can vary in accordance with a particular device, features or other aspects in accordance with a particular application (e.g. Windows, Mac, Linux, Unix or Palm OS variants, a proprietary OS, etc.). Various programming languages or other tools can also be utilized, such as those compatible with the Java 2 Platform, Enterprise Edition (“J2EE”) or other languages consistent with Sun or other suitable specifications. It will also be appreciated that working memory 310 contents, broadly given as OS 311 and other programs 312 can vary considerably in accordance with a particular application.

FIGS. 3b through 3d, illustrate examples of other programs 312 in working memory 310 of FIG. 3a in greater detail. FIG. 3b illustrates how other programs of a user device (e.g. 105 and 205 of FIGS. 1 and 2 respectively) can include a web browser 312a, other program code that is capable of displaying web pages, or another suitable mechanism for supporting a correspondingly implemented CMUI. FIG. 3c illustrates how other programs can comprise one or more configuration engines 312b (e.g. 111 of FIG. 1) or elements thereof. Finally, FIG. 3d illustrates how other programs 312 can comprise one or more supplier systems 312c (e.g. 103 and 203 of FIGS. 1 and 2 respectively) or elements thereof. While agent network agents (see below) are found to be particularly suitable for implementing a configuration manager or supplier systems, one or more of resident programs, other mobile code or other suitable program code can also be utilized.

When implemented in software (e.g. as an application program, object, agent, downloadable, servlet, and so on in whole or part), a system 100/200 element can be communicated transitionally or more persistently from local or remote storage to memory (or cache memory, etc.) for execution, or another suitable mechanism can be utilized, and elements can be implemented in compiled or interpretive form. Input, intermediate or resulting data or functional elements can further reside more transitionally or more persistently in a storage media, cache or other volatile or non-volatile memory, (e.g. storage device 307 or memory 308) in accordance with a particular application.

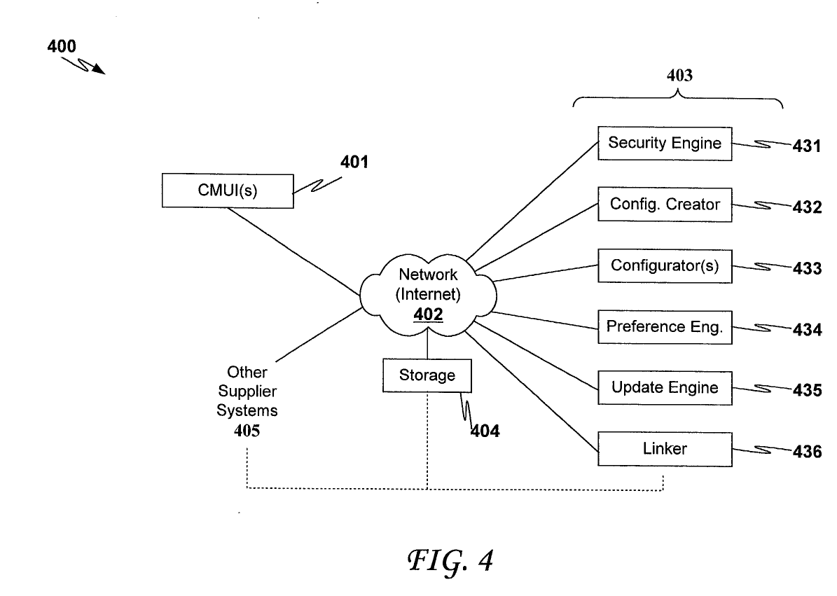

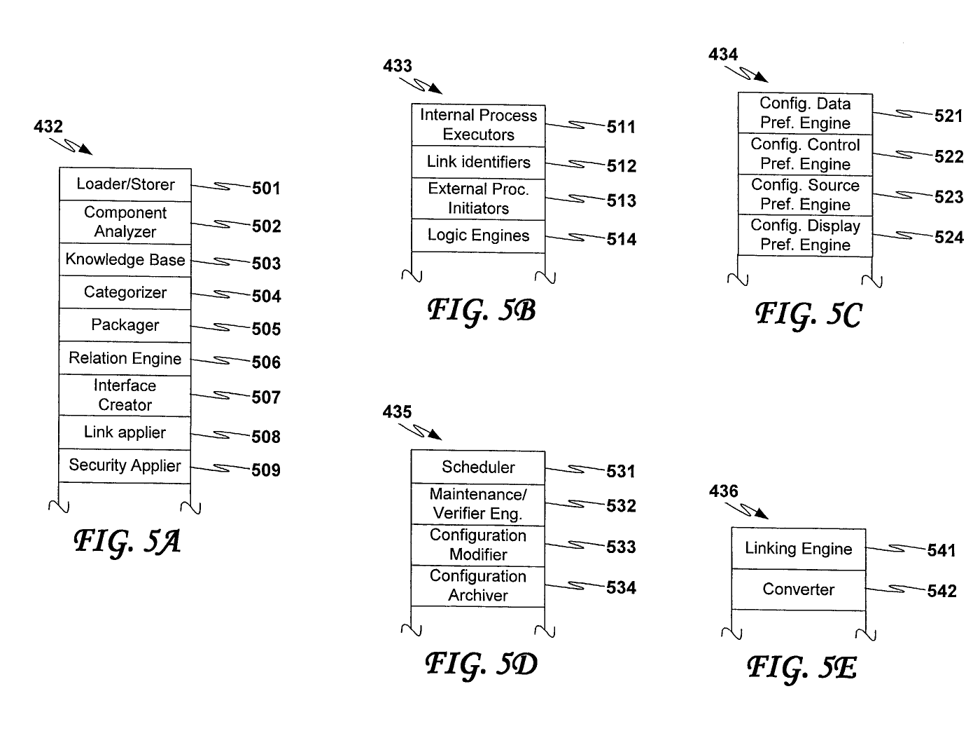

FIG. 4 illustrates a further exemplary configuration manager according to the invention, including elements that are further detailed in FIGS. 5a through 5c. In this example, configuration manager 400 includes one or more configuration manager user interfaces or “CMUIs” 401, which are couplable via network 402 to configuration engines 403 and storage 404.

CMUIs 401 provide web-page based user interfaces that are configurable for enabling users to interact with corresponding ones of the remaining configuration manager elements, typically by providing controls, receiving information from the user, transferring the information to one or more of engines 403 and providing feedback to the user. For example, a security CMUI or CMUI portion (e.g. page or selectable option) can be configured for providing user interaction with security engine 431, a product configuration CMUI or CMUI portion can be configured for providing user interaction with product configurator engine 432, and so on. “Switching” among interactions with different engines can be conducted via corresponding hyperlinks or other suitable CMUI-element linking mechanisms, or switching can be conducted using relational navigation, such as in the below-discussed configuration navigation. Other suitable mechanisms can also be used.

CMUIs 401 are further configurable for enabling user interaction with configuration engines 403 in different manners according to predefined classes of users or other definable classifications. For example, a supplier-user (e.g. supplier employee) CMUI can be configured to provide for interaction with certain configuration engines, such as configuration creation or maintenance, while a customer-user CMUI or other class of suppler/customer-user CMUI is not. CMUIs 401 can also be configured to provide differing access to information provided by one or more of configuration engines 403 based on accessing-user, device or other classifications. For example, a CMUI can provide access to information regarding particular products (e.g. products under development), particular users, user/product summaries, all or some information from other supplier systems 405 or other information in accordance with the above or other user, user system, product, group or other classifications (e.g. determinable by security engine 431), among other examples.

It will be appreciated that different CMUIs need not be utilized to provide the above or other options. For example, a common CMUI might also be utilized with different or variably presentable web pages, hide-able or otherwise modifiable options or using other suitable mechanisms.

FIG. 4 also shows how configuration engines 403 include security engine 431, configuration and product configurator creator/modifier (“configuration creator”) 432, one or more product configurators 433, preference engine 434, update engine 435 and linker 436. In the current example, each of engines 403 is configurable for providing more flexible operation that can further be provided on a user, user device, user group, location or other suitable basis in accordance with various applications. (Note that embodiments enable product configurators 433 and configuration CMUIs to be separately implemented and yet utilized in combination. For brevity, a product configurator and suitable CMUI or CMUI portion will be also be referred to hereinafter in combination as a “product configurator pair” or simply “configurator-pair”.) Security engine 431 provides for determining whether to allow or deny user/user-system access to a configuration system, or further, the type or extent of access that is to be provided. In the current example, security engine 431 is configured to enable predetermined access including general consumer-user access for conducting configuration of available consumer products, extended customer-user access (e.g. for also reviewing purchase information) or variably restricted supplier-user access based on supplier-user function, location or hierarchy (e.g. see above).

More specifically, security engine 431 enables predetermined access by receiving from a customer-user or supplier-user (via a CMUI or CMUI portion) user, user device, group (e.g. company, department, location, workgroup, etc.) or other security information, such as identification or authentication information. Security engine 431 further conducts checking of the received information against identification/authentication or other access information already stored within the configuration system (e.g. within storage 404 or via linker 436), and determines therefrom the type or extent of user access that is to be allowed. Security engine then stores the access information for a current configuration session, the stored access information being available to the remaining configuration system elements. (While access is determinable in the present example for a current configuration system access session only, supplier-system access or other criteria can also be utilized.)

It will be appreciated that other security implementations might also be used in accordance with a particular application. For example, security engine 431 might also be capable of using security information already obtained by another configuration system or other system, or of conducting security in conjunction with such system or enabling such other system to conduct security. Security engine 431 might further enable another one or more types of access without entering security information, or require consumer-user identification or authentication (e.g. for providing user access tracking, review or later user/device, access or other identification). Security engine might also operate as a controller for other configuration system elements, among still further alternatives that might be used in accordance with a particular application.

Configuration creator 432 provides for forming, modifying or maintaining (“creating”) product configurations and product configurators and CMUIs in accordance with which they can be implemented. Configuration creator 431 is configurable to respond to or instantiate a configuration CMUI, in accordance with a security allowance (see above), for conducting configuration, or a configurator can self-initiate or instantiate. (An integrated creation interface can, however, also be used.) Thereafter, user interaction for configuration creating is provided via the configuration CMUI.

FIG. 5a illustrates how exemplary configuration creator 432 includes loader/saver 501, component analyzer 502, knowledge base 503, categorizer 504, packager 505, relation engine 506, interface creator 507, link applier 508 and multiple utilization security applier (“security applier”) 509.

Loader/saver 501 (FIG. 5) provides for causing existing product configurators, CMUIs, configurator pairs, CMUI/product configurator structures or other configuration information to be received/imported from or saved to storage 404 or other supply systems 405 (FIG. 4). As noted earlier, a configurator-pair can include combinations of one or more CMUIs and product configurators or portions thereof, which can further include product configurator/CMUI or “configurator structures” and configurator data.

Configurator structures, which can also be stored as part of knowledge base 503, can include one or more of groupings, relation frameworks or relation engines (see below), any links (e.g. for establishing correspondence between a particular CMUI and a particular product configurator), or portions thereof, to which particular configuration data can be added. Configuration data can, for example, include, for a CMUI, multimedia interface portions and control indicators, and for a product configurator, product indicators indicating product, process, service or other product “option” components. Loader/saver 501 can similarly save or load other configuration information corresponding to other configuration engines/CMUIs or portions thereof.

Elements 502 through 506 provide for automatic, user assisted or manual configuration creation. Automatic configuration creation is aided by the observation that despite product differences, certain commonalities can be for products at some level of abstraction, particularly where some corresponding experience has been accumulated. Thus, each of elements 502 through 506, which are further operable with loader/saver 501 for creating, modifying or maintaining a product configurator or CMUI automatically, with user assistance or manually (e.g. via a CMUI).

For example, in forming a product configurator, information sources including configuration options or information from which options can be derived can be loaded using loader/saver 501, such as was already discussed. Component analyzer 502 provides for comparing the loaded information with product configuration structures or other configuration information stored in knowledge base 503, and for determining therefrom data or indicators of data sufficient to provide for navigation of the product configurator and for display in a corresponding CMUI. (So-called “artificial intelligence” can also be used to facilitate automation of all or part of analysis.) Categorizer 504 further provides for organizing the analyzed information singly, while packager 505 provides for forming product element groupings or “packages” that can be selected as a product configuration option, and that can be organized using categorizer 504 and related using relation engine 506. Relation engine 506 provides for determining and forming correspondences between the categorizations. (As will be discussed, such correspondences or “relations” can be suitably provided in a cross-domain manner using logic engines, thereby facilitating a flexibility and efficiency that is unavailable via linking or other mechanisms that might otherwise be used.) While an “options list” as such often does not exist, option indicators can be ascertained from information available to or that can be created by other systems 405 or by hard sources, portions of which can be entered or otherwise loaded electronically. For example, loader/saver 501 is operable in conjunction with the below discussed agent network or other suitable systems for loading a set of one or more bills of materials from one or more manufacturing systems or storage 404; these, tyically as multiple bills of materials, provide listings of all components of all potential product configurations (and not merely those that are being or will be offered according to configurable options). Sets of one or more routings or recipes can also loaded, saved or otherwise handled; these provide listings of all processes of all potential product configurations. Individual material or component or facility descriptions or data, which indicate how a product configuration can be built, can also be loaded, saved or otherwise handled.

More generally, configuration creator 432 is operable for providing information relating to master data of the items being configured, their general functional description or both. A configurator can further be rendered operable in accordance with hard data, such as that of material attributes or one or more bills of material, routing, customer order, etc., softer data, such as the functions of a product/service or its composite items or the functions that a customer is requesting for a product/service as definable in an allowable options list or both. (In both cases, the data can also be rendered structured and thus more readily loadable/saveable, etc.).

Configuration creator 432 is also configurable for implementing configurator creation in a variable manner utilizing, for example, a bottom up, top down or combined approach according to the requirements of particular applications. In a bottom up approach, engineering related configuration information describes one or more products or services (as broadly described above) in accordance with how the products or services are made or the inter-relationships therein. Such an approach enables defined configurations to be utilized more readily and reliably for production of resultant products/services. In a top down approach, configuration can be ascertained or described in accordance with a customer relationship management perspective describing a product and/or service in broader or coarser terms identifying what the customer wants.

Configuration can thus be provided in accordance with advantages or “the best” of both bottom up and top down approaches to the degree necessary to solve a business (or other) problem. For example, configuration creator 432 or a configurator 433 (see below) can provide a consumer with something the consumer can more desirably use for configuration, while also producing more useful implementation instructions (e.g. manufacturing, service crew instructions, financial products and services, (temporary) services skills matching, pharmacutical R&D certification process, etc.). Elements 432 through 436 can also be implemented according to more desirable combinations of predetermined configuration components or information and components or information that can be more desirably accessed concurrently with configuration, among other examples (e.g. see below).

Of the remaining configuration creator elements of the present example, interface creator 507 provides for forming CMUIs or for adding interface data to a CMUI structure. Linking applier 508 further provides for determining element correspondences for which relations are determined to be less suitable or unavailable. For example, where different CMUIs or product configurators are used, linking applier 508 provides for forming correspondences between ones of the CMUIs and ones of the product configurators. Correspondences with information or processes of other system 405 (FIG. 4) can also be formed, among other examples.

Security applier 509 further provides for creating or assigning various allowances (see above), and other elements can also be used. Security applier 509 (and security engine 431 or other such elements) are configurable, for example, to provide for security creating, assigning or implementing based on authentication of a user or other actor in the system (e.g. system, group, location, management, consumer versus supplier, etc.). Authorization can, for example, be implemented based on elements such as per engine type (e.g. per service, service type or at a more specific logic level, such as discussed below), or can determine whether a given engine can be operable or even loaded/saved, for example, by a given user, user device, etc., or further, per engine instance (e.g. given more than one configuration manager active in a system, authorization may be denied with regard to loading/saving or otherwise utilizing various engines at all or to varying extents).

Security can further be conducted according to data type, per data object type (in an objective system), per data instance or per data object instance (in an objective system), e.g., whether data elements/objects are available or can be used in a particular manner (e.g. modified, manipulated) with a given customer order type. For example, a “user” might be able to access or utilize information relating to or that can be related to customer orders from company A but not others, or visa versa, among other examples.

It should also be apparent from the foregoing that such a configuration creator enables configurator-pairs to be formed requiring only a minimum of configuration information (including information for conducting control). It is not necessary to maintain within a configurator-pair all of the source information used to ascertain configuration options. Rather, only sufficient indicators for enabling navigation of a configurator, locating information provided at runtime and presenting sufficient CMUI controls and feedback at runtime need be maintained. In fact, additional configuration or control information can also be ascertained at runtime (see below), such that configuration manager requirements can be reduced even further.

Returning to FIG. 4 with reference to FIG. 5b, product configurators 433 provide a flexible operational “back end” for conducting product configuration or performing other operations relating to product configuration or for which product configuration operation implementations according to the invention provide a particularly suitable mechanism (e.g. see above). At runtime (e.g. during user product configuration), a product configurator receiving product configuration selections of a user (via CMUIs 401) causes one or more corresponding product options to be selected; user selection also causes any further corresponding configuration manager or supplier system operations to be conducted and next available options in view of the selection to be determined.

The configurator also causes the selection, further corresponding operations or results thereof, and any similar next available options or “navigational advancing” of a corresponding CMUI to occur. Note that “next available” and “advancing” do not imply direction, but rather navigation within the above-noted predetermined navigational framework of the present example that is capable of multi-directional navigation (e.g. forward, backward, restart, etc.) responsive to received control indicators. A more detailed example is provided below.

Exemplary configurator 433 includes internal process initiators 511, link identifier 512, external process initiators 513 and logic engines 514 (FIG. 5b), which are operable in conjunction with operations provided by security engine 431, preference engine 434, update engine 435 and linker 436 (FIGS. 4 and 5c-e). Internal process initiators 511 provide for responding to a received option selection control indicator, such as from a CMUI, by causing a current configurator operation (e.g. selecting a current product option, navigating, further in accordance with security or preferences, etc.). Link identifier 511 provides for further configurator processing, identifying one of more than one CMUIs or identifying supply system processing. External process initiators 513 provide for initiating such external processing as indicated by link identifiers 512; internal process executors 512 provide for such other internal processing (e.g. which can further incorporate external processing results).

Finally, logic engines 514 provide for navigating product configuration options in a cross-domain manner, using logical elements in this case (e.g. “and”, “or”, “not”, “exclusive or”, etc.). It will be appreciated that such cross-domain navigation enables high degrees of flexibility and efficiency. For example, a similar manner of navigation can be applied to different products, thereby simplifying configuration creation and automated creation, operation, etc. Different configuration manager elements, such as CMUIs and configurators can also operate separately yet in a coordinated manner by initiating the same relational navigation (e.g. the same application of logical elements), so long as each responds in a coordinated manner (which can be further facilitated by using corresponding element organizations, such as with configuration creator 432 of FIG. 4).

Such navigation is also extensible to other configuration system elements, such as security, preferences or other features, or supplier systems 405 (which can further include other entities throughout a supply chain) or other systems, where such systems are similarly organized or even where they are not. Where such features or systems are similarly organized, only the received navigation need be transferred to such systems (e.g. by initiation of external process initiators 513 and linkers 436, as in the present example). Where such features or systems are not similarly organized, organization information can be efficiently transferred to such systems (e.g. as in the present example), loaded by such systems or otherwise provided, and with particularly low bandwidth. Thus, interoperation of separate yet coordinated systems, further concurrent operation, and still further real-time information coordination, compilation or other processing is enabled. (Such navigational elements, and particularly logical elements, are also readily implementable in hardware or software, among other advantages.)

Reliability, updating and maintenance of inter-operative systems are also improved in accordance with the above navigation, organization, linking or element transfers. For example, pricing need not be incorporated within a configurator-pair and can instead be accessed from a supplier system or component supplier system concurrently (in substantially real-time) responsive to user selection of configuration options. Thus, not only is configurator size reduced, but errors that might otherwise be introduced by requiring multiple instances, updates and maintenance of such pricing can be avoided. Enabling such concurrent operation also facilitates assuring the viability of such information, since changes or special allowances in pricing or other information (e.g. manufacturability, component availability, inventory, etc.) can be reflected in conjunction with current or even prior user selections (e.g. where a user can still be alerted). Automated or third party intervention is also facilitated (e.g. checking multiple sources of information or supplying “good customer” selections to a manager system or manager that can concurrently authorize special pricing, delivery, manufacturing or inventory priority, etc.), among other examples.

Returning again to FIG. 4 but with reference to FIG. 5c, preference engine 434 provides for modifying or selecting an information source, content or presentation during user access of a configuration system, which can further be conducted in accordance with security/classifications, e.g., as given above. Preference engine 434 receives user selections (e.g. via CMUIs 401, which are modifiable in accordance with security/classifications, as already noted) and causes allowable user configuration preferences to be modified in accordance therewith. Preference engine is also configurable (and can present options) such that preferences can apply to a current session, generally (e.g. via configuration creator 432), automatically (e.g. via defaults, according to other user selections, etc.) or in another manner in accordance with a particular application.

As shown in the FIG. 5c example, configuration preferences can effect the manner in which configuration or other information is ascertained by configurator 433, presented by CMUIs 401 or both. Configuration data preference engine 521 causes selected data types to be transferred or further processed as needed by configurator 433 and modifies a displayed CMUI according to a default or user display preference effectuated via configuration display preference engine 524. Configuration control preference engine 522 provides for specification or modifying controls either in accordance with displayed data or according to received user control preferences. Configuration source preference engine 523 provides for specifying or modifying data sources usable for configuration. Finally, configuration display preference engine 524 provides for specifying or modifying the manner in which data is presented to the user.

Continuing with reference to FIG. 5d, update engine 435 (FIG. 4) provides for automatic or user assisted modifications or other operations relating to changes in configuration system data or the manner in which such data is provided. Scheduler 531 provides for effectuating or verification of changes or data/indicator archival according to one or more predetermined time periods, time/date indicators or events. Scheduled updates can occur, for example, where a new configurator or configurator portion has been created and is scheduled to replace an existing configurator, or a data source or available data within a supplier system is scheduled to be modified at a predetermined point in the future. In the prior case, the update engine 435 causes configurator creator 432 to substitute the new creator for the old one and (optionally) to archive the old configurator for later reference. In the latter case, maintenance-verifier 532 might further be used to first check whether the scheduled change has occurred before initiating requisite CMUI or configurator updates to accommodate the changes (e.g. again, by invoking configuration creator 432).

Of the remaining exemplary update engine 435 elements, maintenance-verifier engine 532 causes linker 436 to transfer a verification request to a supplier system corresponding to an update event or request. Upon receiving a verification indicator, maintenance-verifier engine 532 initiates configuration modifier to conduct the update; if not verified, the event or request can be ignored or a message can further be provided to the user or an corresponding third party or third party system. Configuration modifier 533 responds to a received time/event or user request by conducting modifications alone or by initiating configuration engine modification operations or by causing configuration archiver 534 to store a change indicator and any corresponding data (e.g. where an after sale modification has been made by a supplier or user). Finally, configuration archiver 534 causes modifications to be stored when invoked, upon user request or on the occurrence of one or more scheduled times/events (e.g. 11 pm, once a week, on some other “release schedule,” where a corresponding system is available or further is available according to predetermined conditions, etc.).

Continuing with reference to FIG. 5e, linker(s) 436 provide for facilitating interoperation of configurators 433 and other systems. As noted, other systems can include CMUIs or other supplier systems, which can extend generally to any system that is at least temporarily couplable thereto, but more practically to such systems that do not substantially impede configurator operation. A linker can operate as a more centralized connection initiator for initiating connection between configurators 433 and other elements or systems, as in the present example (or more suitably as a below-discussed broker agent within an agent network). Alternatively, more than one linker, one or more connection points or one or more integrated or otherwise connectable configuration manager elements can be used.

Linkers 436 of the present example include linking engine 541 and converter 542. Linking engine 541 receives an indicator indicating a request by a configurator to become coupled with another configuration manager or supplier system element, resolves the indicator to an element address, initiates a coupling and then substitutes the configurator for itself in the coupling. Converter 542 provides for performing any conversion that might be necessary for communication between the configurator and the supplier system element.

It should also be noted that storage 404 of FIG. 4 can include one or more intra or extra configuration manager storage elements in accordance with a particular application.

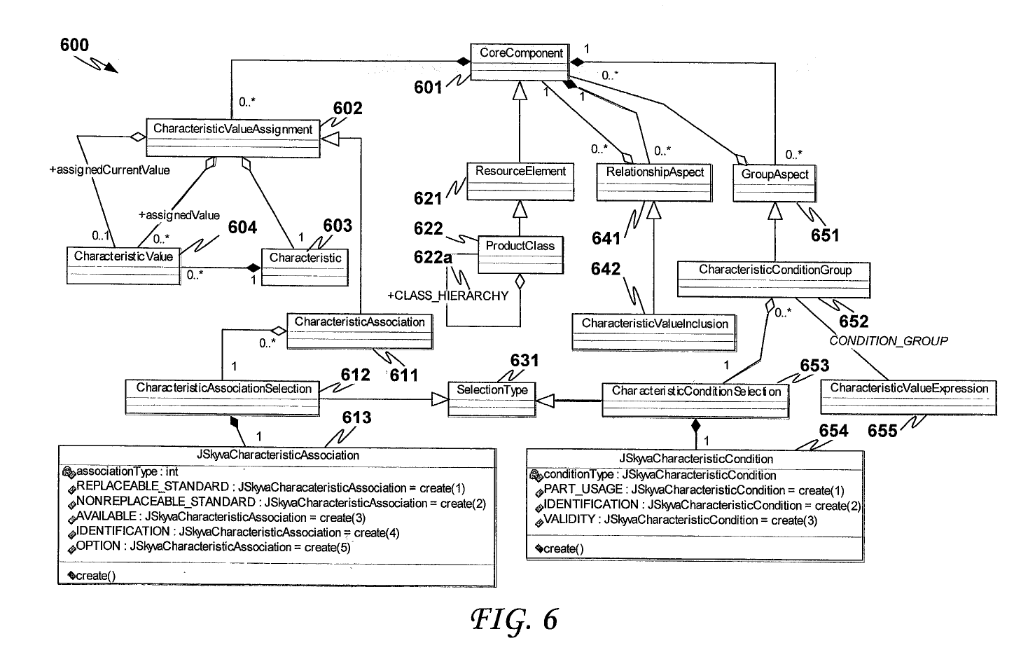

FIGS. 6 through 12 illustrate an exemplary configurator 600 that utilizes a meta model realized as objects in accordance with object oriented programming (“OOP”).

Turning first to FIG. 6, configurator 600 is more easily understood as being created as a “feature classification” product hierarchy (hereinafter “FCPH”) that utilizes a nested tree architecture. While the illustrated FCPH example is tailored to provide an extension to a business modeling technique and an agent network for providing product configuration features, it can also facilitate product configuration generally. (For example, CoreComponent 601 can be considered a root object in accordance with the discussion that follows.)

The depicted FCPH example appears particularly suitable for product configuration. It can be formed by abstracting several product classes up to a parent product class, thereby enabling inheritance of specifications from a parent and avoiding data repetition. Yet it is capable of supporting the above-noted configuration option groupings. It is also capable of supporting the above-noted relating of configuration groupings or “rule expressions” for defining required/prohibited option configurations in conjunction with both individual and package options. Moreover, the FCPH provides for defining a solution space in which “product components” form generic nodes that can be associated with all allowable option solutions; each possible option solution can further be qualified by specifying a configuration condition requiring the use of a specific component. The FCPH can also serve as a template for defining all configurations of a product in a consistent manner, among other aspects (e.g. see configuration manager above).

FIG. 6 shows how sets of products produced by a particular product supplier or “enterprise” can be related and grouped using ProductClass objects (e.g. product class 622). Each ProductClass can be related to options or features that define the configurable characteristics of products of an object, and a hierarchy of ProductClasses is defined to allow shared features to be pushed up and defined on a common parent ProductClass, thereby forming the FPCH. (A ProductClass might, for example, include trucks, 2-door cars or Japanese laptops.) FPCH 600 also enables ProductClasses to be sub-classed and specialized for applications within different domains. A “level_type” (field) can further be added to such a subclass for specifying the level or category of the ProductClass within a hierarchy. For example, FPCH 600 enables product levels within an enterprise to be configured as follows: An “enterprise-level” can define a specification or category for all ProductClass objects in the enterprise, including different brands or companies of the enterprise; a “platform-level” can group products based on the same general concept; a “family-level” can group all products having a common base and fixed set of characteristics; or a “typelevel” might group products by marketing range. Other levels might of course be used alone or in conjunction with the foregoing examples. (Using the foregoing levels, it is observed that distinctions between standard characteristics are usually made at the type-level.)

FPCH 600 further provides for representing features and specifications of ProductClasses using a Characteristic and CharacteristicValue model. According to the Characteristic model portion, a characteristic defines a set of features that serve the same purpose or function. (E.g. Characteristic 603 and CharacteristicValue 604). For example, a “Hard Disk Size” Characteristic can be defined wherein Characteristic Values define specific hard drive sizes, such as 850M, 4G or 16G. The CharacteristicValue model portion further provides for specifying a characteristic, feature or option of a ProductClass that may be used within a product's structure to select among a set of possible Item solutions (e.g. specifying “voltage” as a Characteristic instance and “specific voltages”, such as 110 volts, 220 volts, as CharacteristicValue instances). CharacteristicValue can also be used to define an option package in which a “package” CharacteristicValue groups a set of “individual package options” CharacteristicValue instances.

FPCH 600 does not, however, require Characteristic to contain Characteristic Values that apply to all instances of a particular ProductClass. Rather, as illustrated, a CharacteristicAssociation (e.g. 611) can be used to indicate the specific Characteristic Value instances that apply to each ProductClass and how the product specification is to be used for that Product Class.

In the FIG. 6 example, a CharacteristicAssociation provides a qualification for the use of a CharacteristicValue (e.g. 604) against the associated ProductClass. The following CharacteristicValues are provided in the current example: “Replaceable_Standard”, wherein the CharacteristicValue is a default characteristic for the product belonging to the ProductClass, as long as no other specification of the same Characteristic has not been chosen; “Non_Replaceable_Standard”, wherein the CharacteristicValue is an unconditional characteristic of any product in the ProductClass; “Availability”, wherein the CharacteristicValue is a potential characteristic of the ProductClass, and is not specified if this is an option or a standard; “Identification”, wherein the Characteristic Value is a characteristic that allows the associated ProductClass to be distinguished from other ProductClass objects. (This is similar to a non replaceable standard); and “Option”, wherein the CharacteristicValue is a characteristic of a product only if explicitly chosen. (Option can replace a replaceable standard Characteristic of the same category.)

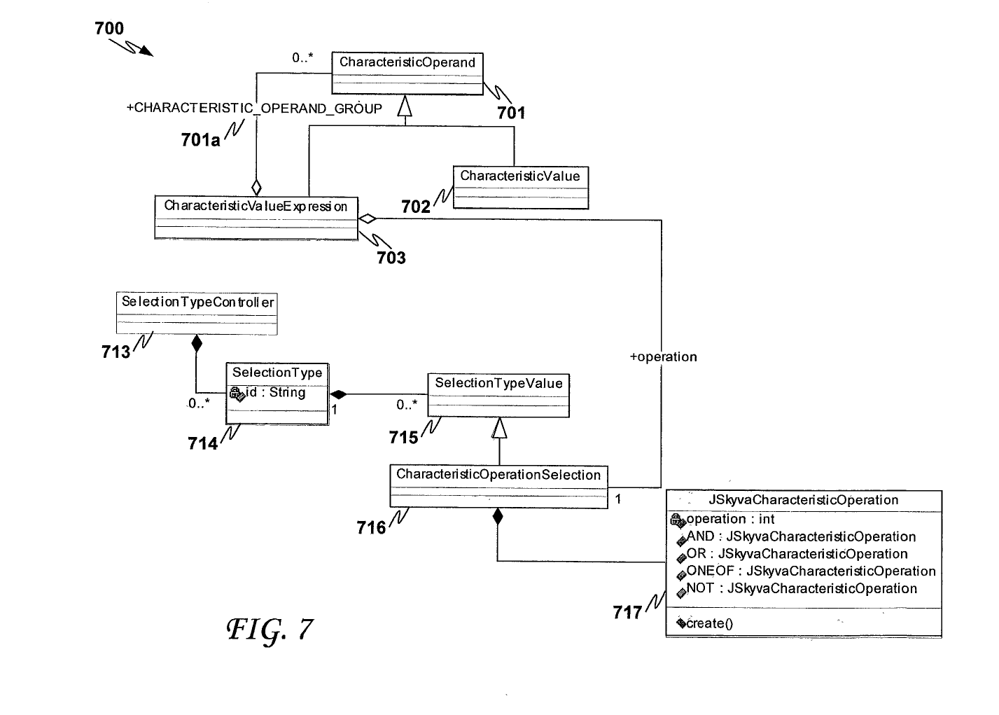

CharacteristicExpression 703 (FIG. 7) enables CharacteristicValue 702 instances to be combined by simple Boolean operations. For example, a user selection of the color gray for the exterior of a car can limit the availability and thus user selection of soft-top color to blue and black, excluding the color green. Nesting of expressions is provided by making both CharacteristicExpression 703 and CharacteriticValue 702 implement CbaracteristicOperand interface 701.

Characteristic_Operand_Group 701 a holds the set of CharacteristicOperands associated via a Boolean operator provided through CharacteristicOperationSelection 716. CharacteristicOperationSelection 716 of the present example provides the following Boolean relationships between the CharacteristicOperands: “And”, wherein all of the grouped CharacteristicValue instances apply; “Or”, wherein any subset or all of the identified CharacteristicValue instances apply; “One Of”, wherein exactly one of the identified CharacteristicValue instances applies; and “Not”, wherein the identified CharacteristicValue instances must not apply.

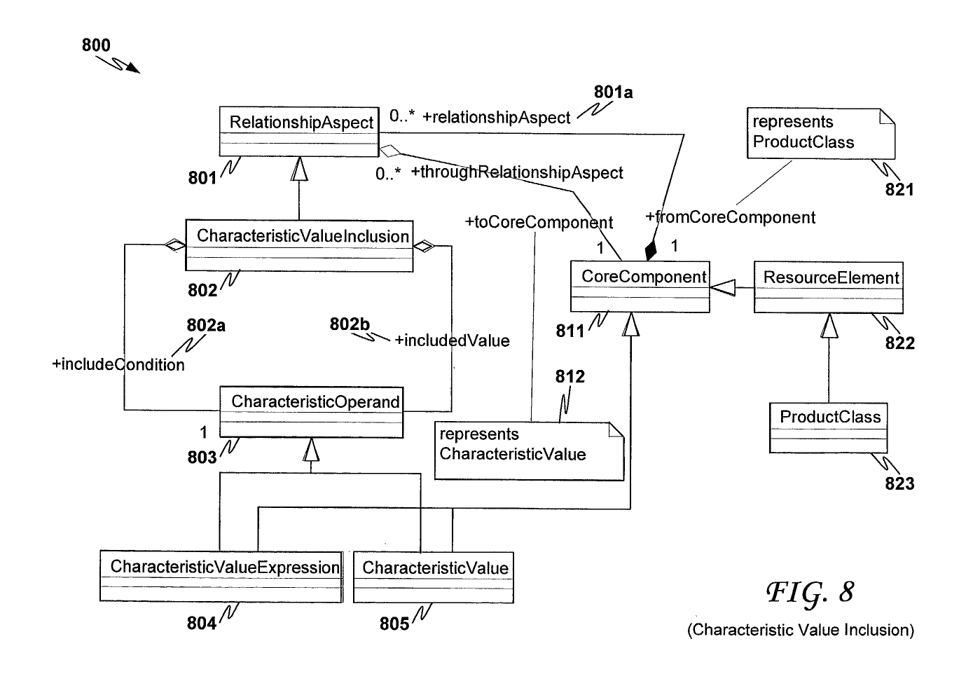

FIG. 8 illustrates how FPCH 600 of FIG. 6 also provides for characteristic value inclusion. CharacteristicValuelnclusion is an optionally implementable representation that the application of a CharacteristicValueExpression (FIG. 7) implies or requires the inclusion of an additional CharacteristicValueExpression. The CharacteristicValue Inclusion 800 example is modeled for enabling rules to be specified that define dependencies between product options or combinations of product options. Selecting an option for a ProductClass can result in the inclusion or exclusion of the availability of options related through a CharacteristicValue Inclusion specification.

CharacteristicValuelnclusion 800 is also modeled as a subclass of Relationship Aspect 801 between a ProductClass and CharacteristicValue. Thus the selection of a particular CharacteristicValue instance for a ProductClass can trigger inclusion rules through the CharacteristicValuelnclusion that links the CharacteristicValue instance with the ProductClass instance. The inclusion rule itself is modeled by two attributes in CharacteristicValuelnclusion 802. The first attribute, includeCondition 802a, specifies a CharacteristicOperand 803 (a CharacteristicValue or CharacteristicValueExpression) which represents an IF condition. Should the IF condition evaluate to TRUE, then includedValue attribute 802b specifies a CharacteristicValue 805 or CharacteristicValue Expression 804 defining the CharacteristicValue instances which should be included (or excluded) as a result of the selection.

CharacteristicOperand 803 is an abstract class, and the CharacteristicValue class and the CharacteristicValueExpression class are its sub-classes. Sub-classes of the CharacteristicOperand 803 may be used for both the includeCondition 802a and the includedValue 802b of the CharacteristicValuelnclusion object 802.

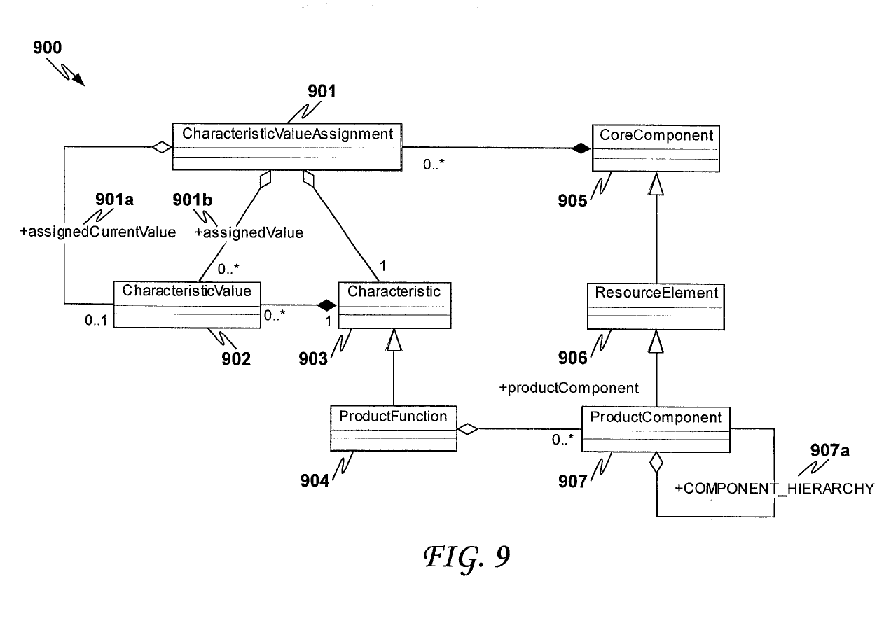

Continuing with FIGS. 9 through 12, the illustrated ProductComponent class 900 example is a generic representation of a functional component in a product structure to which all of the physical parts that provide the generic function are associated. The associating of ProductComponent 900 to a particular Part can further be qualified, via the ProductSelection, to indicate a specification condition when the physical part is to be used. ProductComponents 907 can also be associated together to form functional decomposition of the Product Structure and a template to which all variations of the product structure must conform.

The top level ProductComponent of the ProductComponent structure is associated to a ProductClass. Each ProductComponent object is further associated to a set of ItemSolution objects that identify parts meeting the ProductComponent's functional requirements. The design of a new product that belongs to an existing ProductClass begins by reviewing all the possible ProductSelections for each ProductComponent in the decomposition structure and identifying those ProductSelections that can be used in the new product by adding or changing the various ProductClass characteristic relationships.

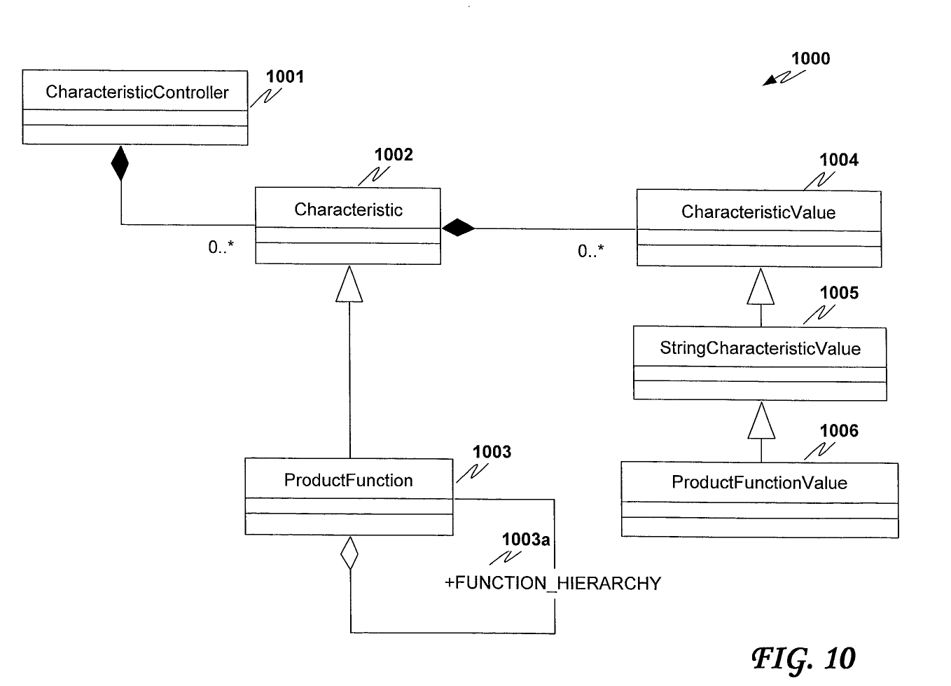

The ProductFunction 1003 example of FIG. 10 is a subclass of a Characteristic Framework element that represents the purpose or function that a ProductComponent object (e.g. 907 of FIG. 9) fulfills for the product that contains it. Using Function_Hierarchy 1003a, a functional decomposition and classification hierarchy can be built. The ProductFunction and the ProductFunction hierarchy provides for associating ProductComponents from different ProductClasses, thus enabling a user to view parts serving a similar purpose not only within a ProductComponent but also across ProductComponents and ProductClasses. For example, “interior illumination” and “exterior illumination” functions can be related to an “illumination” function, thereby providing for grouping together all Product Components (and their related parts) that provide some type of illumination.

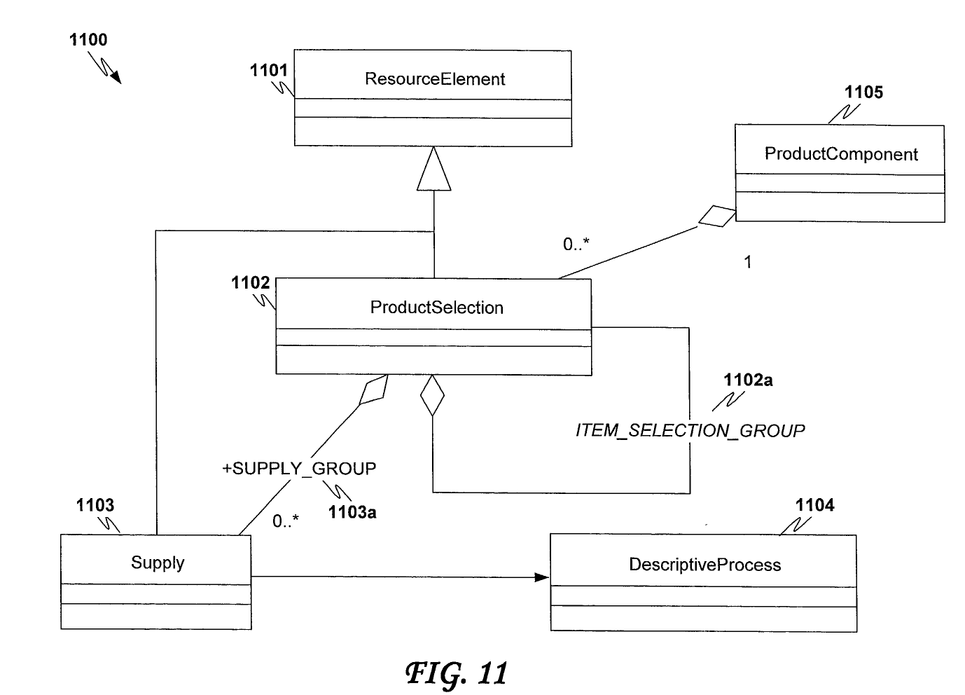

The ProductSelection 1100 example of FIG. 11 defines a solution to the function requirement defined by a ProductComponent. A ProductSelection may represent a technical solution, such as ‘Disc brake’ or ‘ABS brake’ for Product Component ‘front left brake,’ or a part solution, which identifies a specific set of Supply that jointly fulfill the functional requirement, e.g., the part number of a tire that may used on a car. Multiple Supplies can also be associated to a single ProductSelection to represent a kit of parts that jointly fulfill the ProductSelection, and ProductItem Solutions for the same ProductComponent represent mutually exclusive alternatives. The association with the Configuration object identifies the condition (Specifications) and the effectivity under which the ProductSelection is considered valid. (Note that the implemented attribute name is used to specify a unique identifier for an instance.)

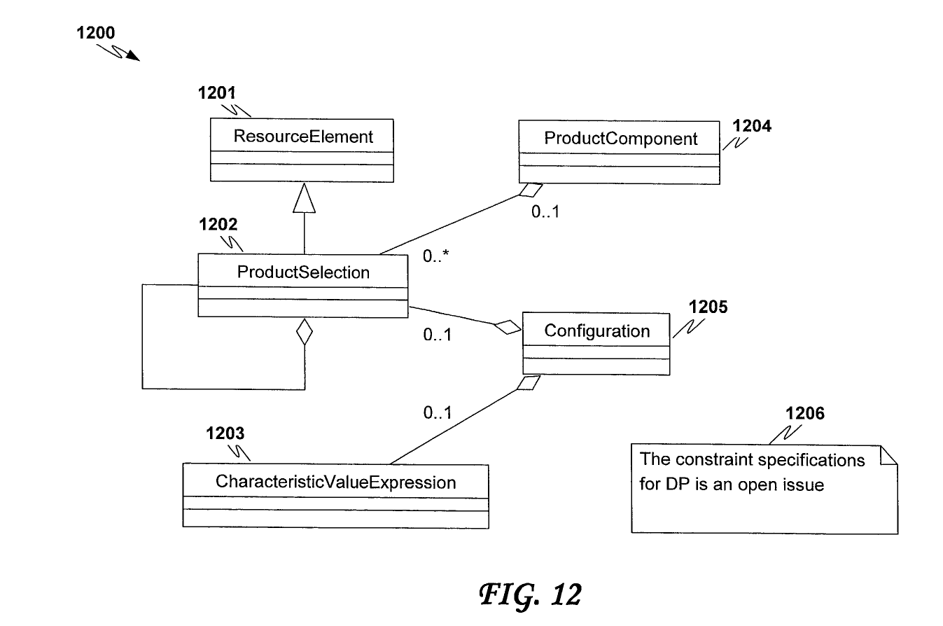

Finally, the Configuration example of FIG. 12 provides an association of a Characteristic Value or CharacteristicValueExpression 1203 (which identifies an option or set of options selected), an Effectivity (valid time range for which the association applies), and a ProcessOperation or ItemSolution. Since the Configuration can alter the content of a product's BOM, it may also be necessary to alter the process operation steps that describe how to assemble the optional part. Therefore, the configuration not only has the ability to qualify the usage of a particular part, but also qualify the use of a particular process operation. Each Configuration may control its usage by time, serial numbers, or lot numbers via effectivity.

The link with the descriptive process for the above example takes place at the descriptive process element or “DPE” level. DPE's (which can include a descriptive process and its elements) can be considered independently from and modeled independently-even orthogonally-by the product configuration. The DPE models the particular production operation, which can be treated as independent from the configuration as well. The DPE can also have nested DPEs, thereby enabling modeling of a complete functional production activity (e.g. Assembly) as group of operations. If a production meta-model exists (i.e., the generic production process for a product, such as a car), the configured product instantiates the DP for the planning, scheduling or execution of that order. If a production meta-model does not exist, then a recursive algorithm explodes the DPEs structure starting from the configured product to go step by step deeper into the DPEs structure to define the DP. The explosion mechanism used provides a demand-supply match at DPE level. The DP building mechanism is not linear in the particular implementation, but has a recursive structure.

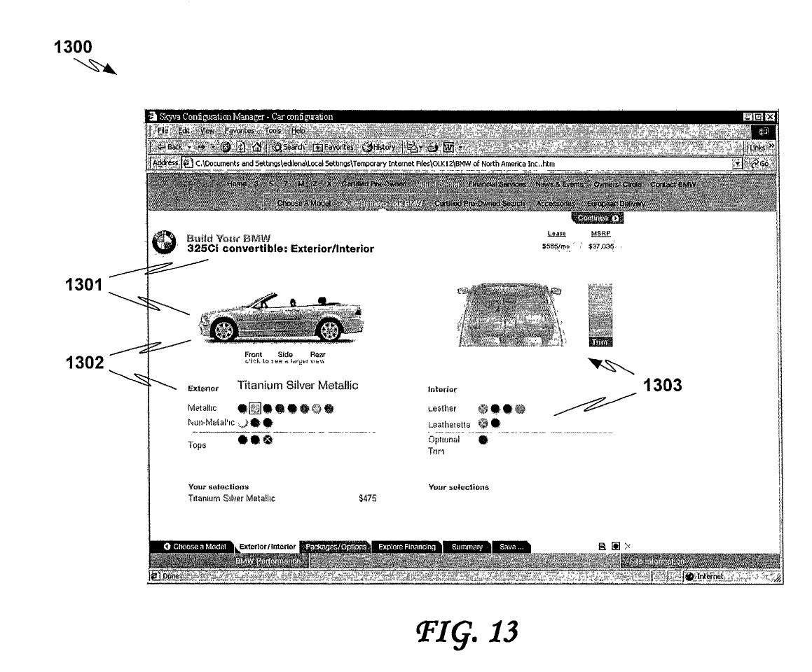

FIGS. 13 through 19 illustrate an example of a configuration according to an embodiment of the invention. The example is provided from an application perspective, using alternating an “walk through” type figure sequence. The sequence of figures shows configuration manager user interfaces (“CMUIs”) and configurator details, including portions of a configuration solution space, option groupings and logical elements that might be utilized, and resulting navigations through a configuration. (The depicted example more specifically considers the configuration of a car, in this case, a BMW™.)

The example of FIGS. 13-20 is also used to further detail an exemplary operational flow of configuration system elements. For convenience, such details are presented in accordance with the objective embodiment of FIGS. 6 through 12. It should be noted, however, that other operational characteristics and other characteristics might also be employed, and further, in accordance with other implementations enabled by the invention.

Turning first to the FIG. 13 CMUI 1300 example, an underlying configuration manager is configured such that the first requirement for a configuration system user performing configuration is to select a model of car and the exterior color of the car. (The depicted CMUI elements are as presented to the user after the car model has been selected.) When selected by the user via the CMUI, selection of the car model 1301 and exterior color 1302 reduce the number of choices for the selection of the color of the top 1302 and the car interior 1303 (which selections and results are correspondingly presented as multimedia feedback to the user) by constraining the space of possible selections. For example, the selection of the metallic paint color gray excludes the possibility of selecting the Blue Top and the Beige Leather or Leatherette color for the interior of the car.

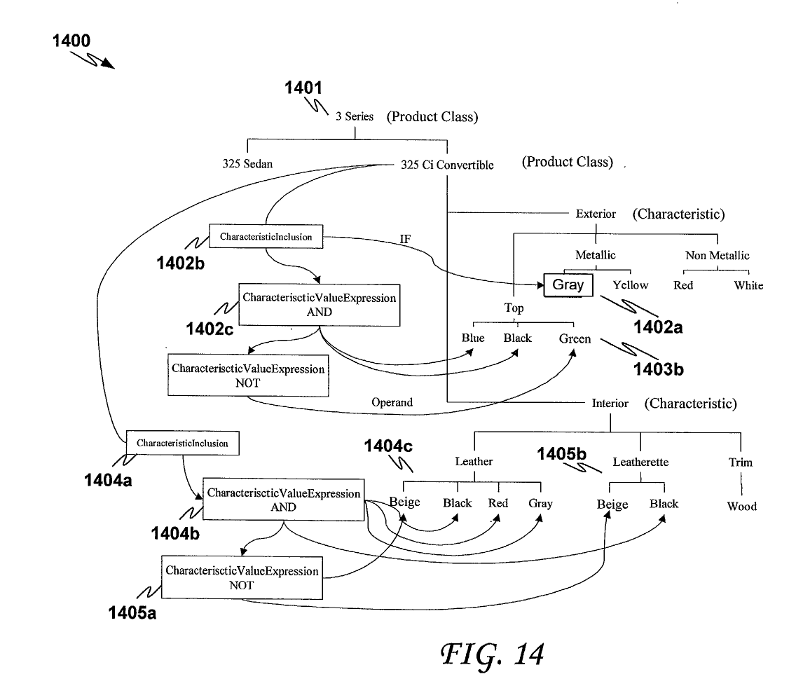

FIG. 14 illustrates a model representation engineering view of a configurator 1400 corresponding to the end-user CMUI 1300 of FIG. 13. As shown, the selection of the Characteristic Gray 1402a triggers CharacteristicInclusion 1402b to evaluate Characteristic ValueExpression 1402c with the instance AND. This allows the selection of the color Blue and Black, and CharacteristicValueExpression 1403a with instance NOT, which excludes the color Green for the Characteristic TOP (1403b). Concurrently, for the Characteristic Interior, the selection of the external color Gray triggers the evaluation of CharacteristicValue Expression 1404b with the instance AND, which allows the selection of the color Black, Red and Gray for the Leather and Black for the Leatherette (1404c), as well as the evaluation of CharacteristicValueExpression 1405a with the instance NOT, which excludes the color Beige for both Leather and Leatherette Characteristics (1405b).

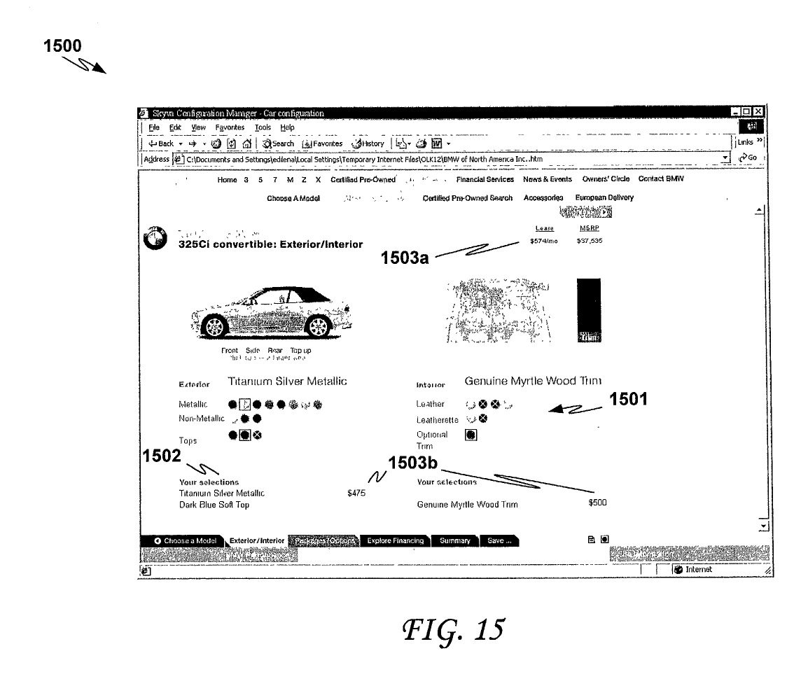

Turning to CMUI 1500 of FIG. 15, after the selection of the exterior color, the CMUI further provides for the selection of a car top color. (Note, however, that the underlying configuration manager need not require sequential user selection as in the present example, and can be similarly configured to provide for different, multiple or even random selections. The configuration manager can further provide for various types multimedia feedback that need not be limited to text or graphics, or feedback to a user, such as was already discussed. Any suitable mechanisms can be used for providing more specific static, dynamic or interactive user presentation of multimedia data.)

Assuming, in FIG. 15, that Top color Blue is selected, then additional constraints are activated for the selection of the interior color 1501. Here, for example, Leatherette color selection and selection of Black and Red Leather are further no longer available. Additional feedback is also provided. For example, CMUI 1500 now presents a listing of user selections 1502, pricing options 1503a and costs corresponding to user-selected options 1503b. As discussed above, such configuration information can be incorporated within a configuration manager, provided concurrently or otherwise by an other interoperable system or both. User activity or results can further be provided to such interoperable systems.

Pricing might, for example, be provided by a supplier planning/operations system upon user selection, or further in conjunction with automated or manual review of the selection by a supplier system or supplier system user. Component, processing or delivery availability might also be similarly verified with one or more supplier inventory, manufacturing or delivery systems, or further with systems or system users of other entities, such as component suppliers, among other configurable options.

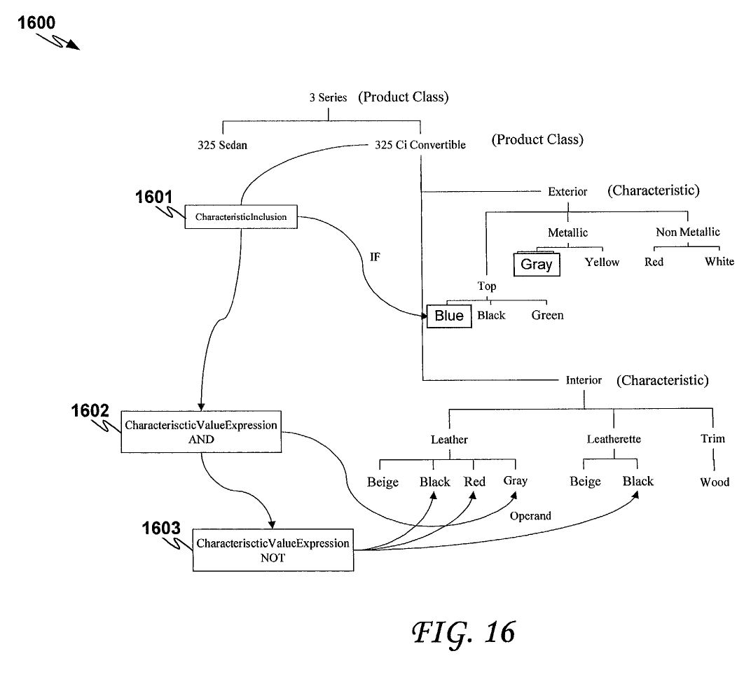

FIG. 16 illustrates the operation of the underlying configuration manager corresponding to user selection options of FIG. 15. For example, selection of the color Blue for the Characteristic Top triggers CharacteristicInclusion 1601 to evaluate CharacteristicValueExpression 1602 with the instance AND (which allows the selection of the color Gray), and CharacteristicValueExpression 1603 with instance NOT (which excludes the color Black and Red for the Characteristic Leather and Black for the Characteristic Leatherette). Note also that the Characteristic Trim is not affected by any of the selections made. Even though not shown in FIG. 16 (for clarity sake), a CharacteristicValueExpression with the instance AND is evaluated for it in each of the selections previously made.

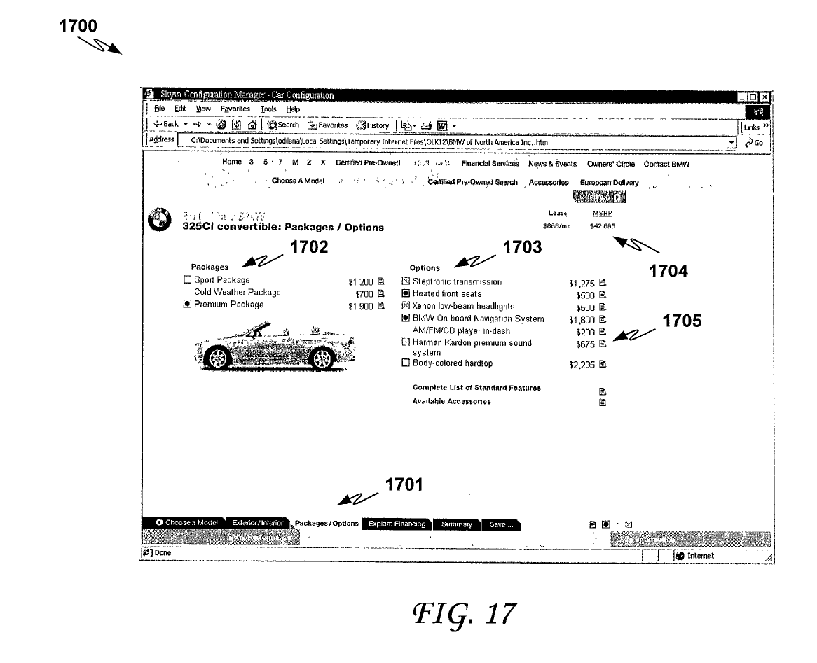

As shown in the CMUI of FIG. 17, completion of the above selections or user selection of a “page tab” control (1701) trigger CMUI navigation, such that CMUI 1700 now provides for additional user selection of the illustrated single feature or package options 1702, 1703. Assuming that the user selects the Premium package, then the Options Steptronic transmission, Xenon low-light headlights and Harmon Kardon premium sound system are not available anymore under the option list. Since these options are already included in the selected package, selecting the package triggers exclusion of the individual options. Similarly, selection of the Heated seats separately or as within Premium package causes the Cold Weather package to be no longer available.

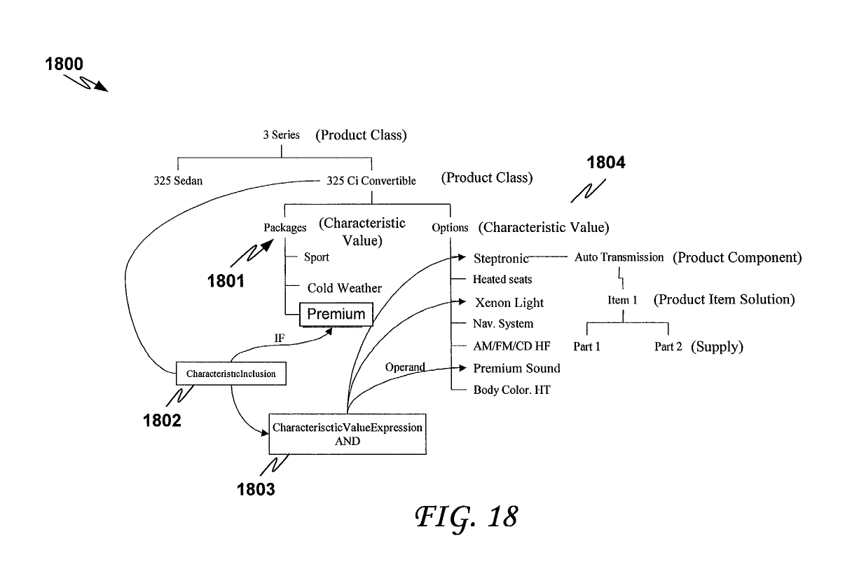

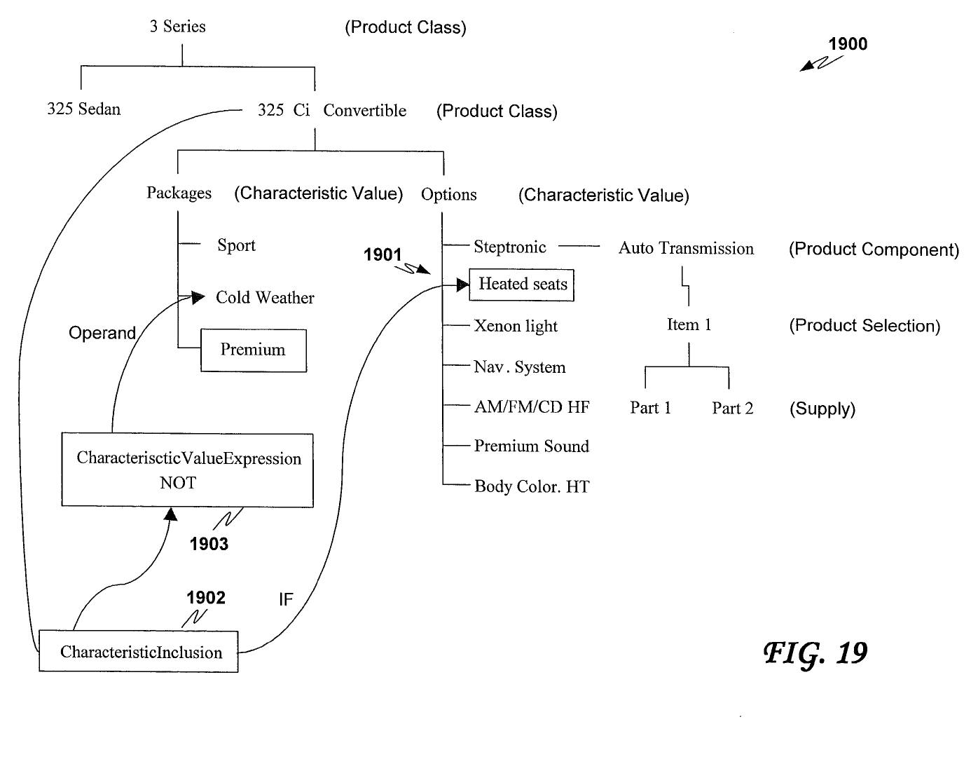

FIGS. 18 and 19 illustrate an underlying model for supporting CMUI 1700 of FIG. 17. As shown in FIG. 18, the selection of the CharacteristicValue Premium Package 1801 triggers CharacteristicInclusion 1802 to evaluate the CharacteristicValueExpression 1803 with a NOT instance. This selects the Operands Steptronic, Xenon light and Premium sound belonging to the CharacteristicValue Options 1804, with the result that they are no longer selectable as individual features. FIG. 19 further shows how the selection of the CharacteristicValue Heated seats Option 1901 triggers Characteristic Inclusion 1902 to evaluate CharacteristicValueExpression 1903 with a NOT instance. This selects the Operand Cold Weather belonging to the CharacteristicValue Packages, and thus cannot be selected anymore.

FIGS. 18 and 19 also show links between possible selectable options as single options or as package options, as well as the actual parts related to them. Characteristic Value Steptronic is further shown to be related to the ProductComponent called Auto Transmission, which is linked to the ProductSelection named Item 1, and which further relates to the Supply elements Part 1 and Part 2. This link acts as bridge between the configuration of the product and its billing.

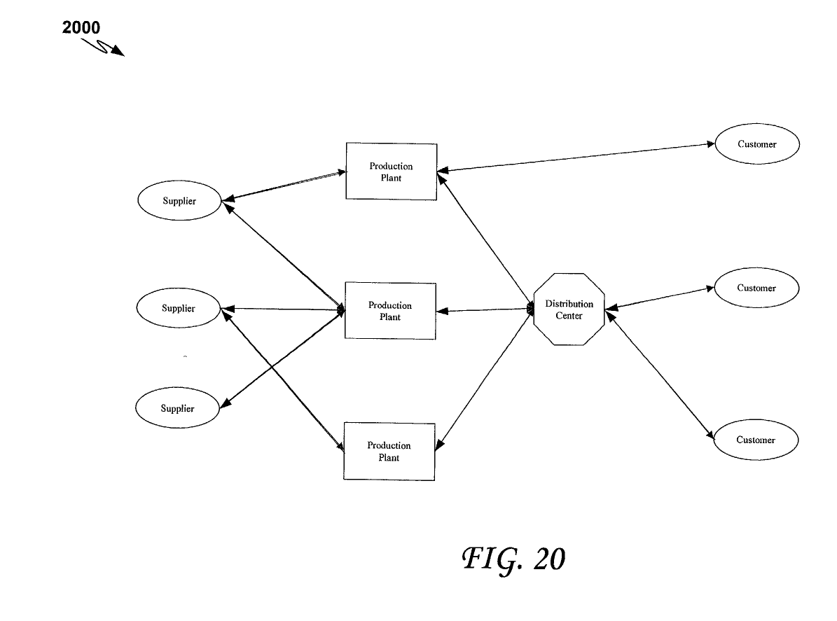

Turning now to the supply chain flow diagram of FIG. 20, it will become apparent to those skilled in the art that configuration embodiments according to the invention can be extended to intra and extra entity commodity, service and other process flow, bringing with it specific information (such as cost, validity time, transportation time, constraints, etc.). Such configuration is further capable of providing a decision support model that captures in full the dynamics of the supply chain.

Using, for example, the characteristic inclusion and expression mechanism aspect, the relationship between a product and its suppliers and production plants can be described via logical operations, such as AND, OR, NOT, XOR, at any level of a product hierarchy (e.g. product family, product component, parts, etc.). For instance, particular product or material relationships with suppliers and manufacturers can be expressed as: material/product xyz AND supplier abc AND plant 123. Note that this method of modeling, does not impose any restriction or constraint, thus enabling the user to introduce at the expression level any variable required, such as cost, time, etc.

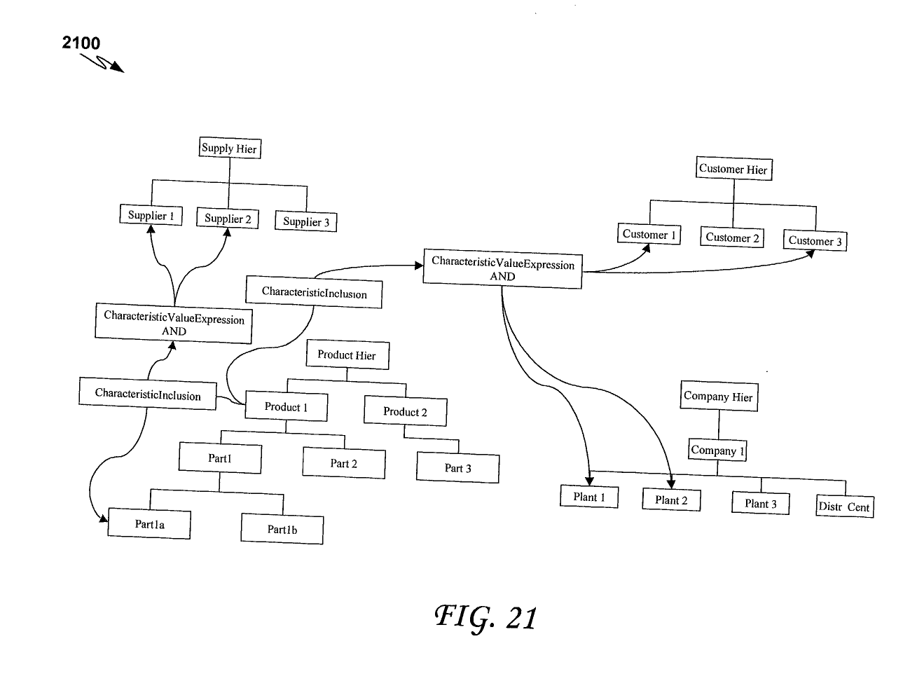

FIG. 21 illustrates an example in which the above configuration system aspects are extended to a supply chain, further applying the objective framework example of FIGS. 6 through 11 above. As shown, Product1 is linked to its markets, production plants, while its raw material is linked to the suppliers. Operands can, in this case, be linked together via an AND relationship. Information regarding costs (supplier costs, production costs etc.), validity time, transportation time and other constraints in general are defined within the framework and are linked to particular products, for example, in the manners already discussed. Values and other information are further passed through a CMUI; these can be pre-assigned, and therefore unalterable by a user, freely definable, or the above security or preferences can be applied.

The above modeling relations (e.g. logic elements) can then be used to associate separate business hierarchies at any level of aggregation required. In order to support a typical model, for example, the suppliers, the production plants, distribution centers and customers can be modeled as four different hierarchies. The associations between these hierarchies can further be expressed by using relations such as the above logical expressions. Such structure can thereby provide for any kind of planning and analysis for decision support purposes. The system can further provide real time information about a particular product consisting of, for example, the supplier of the raw-material required, the production plan that produces it, where it is stored and what is its inventory level, who are the customers that buy it etc. All of the information can further be made available in substantially real time by evaluating the related logical expressions.

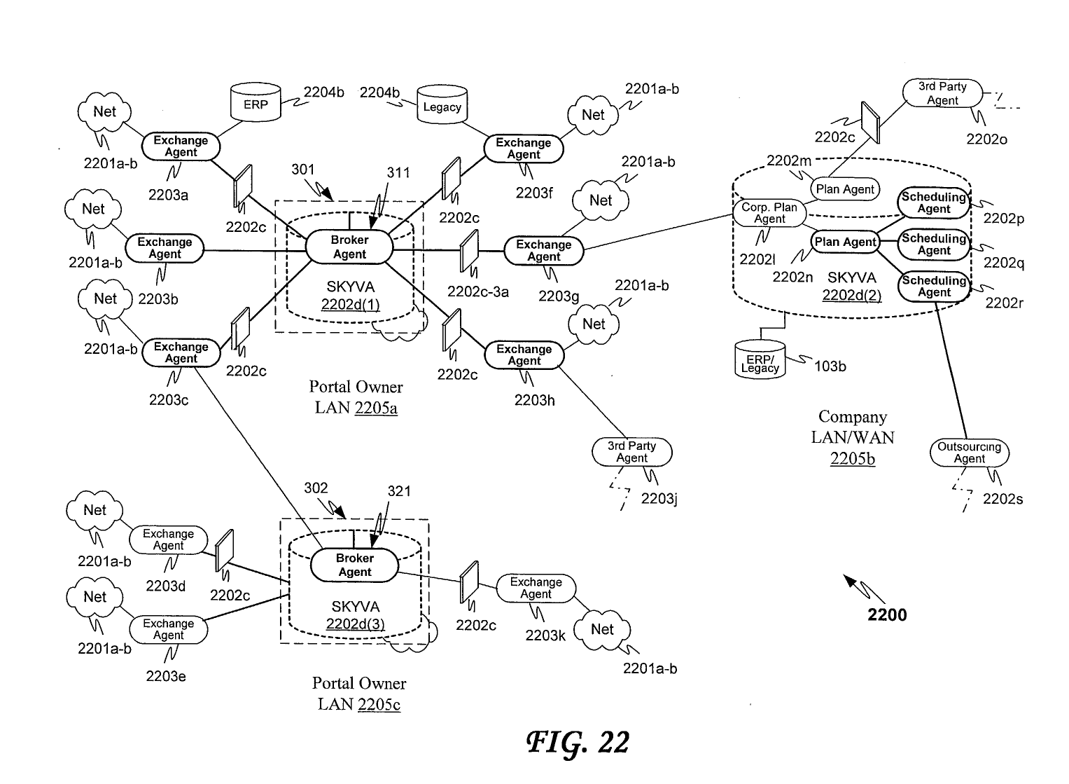

FIG. 22 further illustrates an example of an agent network that is capable of implementing a configuration system according to the invention. FIG. 22 is taken from the above-referenced provisional patent application entitled “Distributed Artificial Intelligent Agent Network”.

As shown, the agent network 2200 includes distributable agents that are configurable for implementing portions or slices of business processes corresponding to (traditionally) wholly different business functions, and are further capable of interoperating with non-agent network system elements. Agent network 2200 is also capable of virtual implementation, such that the agents can be distributed to varying underlying system hosts (e.g. of an underlying physical network) according to the requirements of a particular application. Thus, for example, one or more of the elements of FIG. 1 or the elements comprising the elements of FIG. 1 can be implemented as elements of one or more agents.

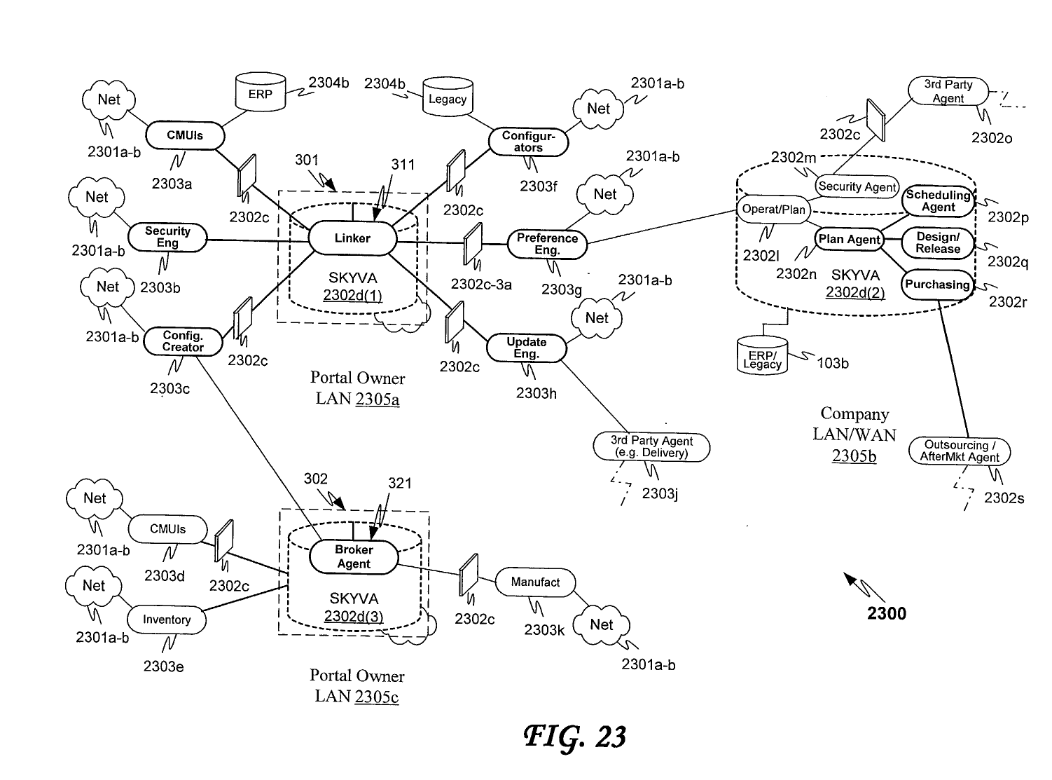

Agents can further be provided as broker agents (e.g. broker agent 2201) which in addition to other potential functionality are also capable of providing connections between other agents. Turning also to FIG. 4, for example, it was noted above intra or extra configuration manager 400 communication within the configuration system can be conducted in a more or less distributed manner, including but not limited to using linker 436 as a mechanism for facilitating such communication (e.g. see FIG. 23). While other implementations might be utilized, a particularly suitable implementation can utilize nonbroker agents to implement one or more of CMUIs 401, security engine 431, configuration creator 432, configurators 433, preference engine 434 and update engine 435 as non-broker agents, and linker 436 as a broker agent. Other supplier systems 405 are also implementable as various combinations of non-broker agents, broker agents or non-agent network components (e.g. existing business system elements).

Broker agents are operable in various manners for facilitating inter-element communication and other operabilities, such as those discussed in the above-referenced provisional application. In one example with linker 436 implemented as a broker-agent and the remaining elements implemented as non-broker agents, an initiating element (e.g. configurator 433) determines an operation that includes transferring, for example, a navigation to another element (e.g. CMUI 401). In this example, configurator 433 would initiate a communication with linker 436, linker 436 would resolve that the navigation is targeted at the particularly implemented CMUI 401 (e.g. via a location list within linker 436). Linker 436 would then initiate a communication with CMUI 401 and then replace itself in the communication with configurator 433. (It should be noted, however, that various implementations of broker and non-broker agents might be used and might conduct various types of unitary, collaborative or other communication in various other manners.)

A further advantage enabled by the above and other implementations of configuration systems according to the invention is that information transferred between elements can be non-descriptive, rendering the communication more secure. For example, using the above navigation, transferring of only a logic element can be used by a configuration manager element to request information from even other supplier systems 405. Other supplier systems 405 further need only respond with the information requested (e.g. price, availability or other information). Such a system not only facilitates interoperability as already noted, but also provides a more secure manner providing information without requiring one system to enable access to another beyond exchanges such as receiving navigation information and supplying responsive information.

While the present invention has been described herein with reference to particular embodiments thereof, a degree of latitude of modification, various changes and substitutions are intended in the foregoing disclosure, and it will be appreciated that in some instances some features of the invention will be employed without corresponding use of other features without departing from the spirit and scope of the invention as set forth.

What is claimed is:

1. A method for modeling a constraint relationship, comprising:
receiving data;
identifying a solution space corresponding to the data;
setting rules for evaluating constraint relationships of the data and for navigating the solution space; and
generating cross-domain logical response engines corresponding to a navigation of the solution space.

2. A method according to claim 1, wherein the receiving data comprises receiving an electronic data file.

3. A method according to claim 1, wherein the data corresponds to at least one of a product offering and a service offering.

4. A method according to claim 3, wherein the data comprises a service description of a service and bill of particulars for the service if the at least one offering includes the service, and a product description of a product and a bill of materials for the product if the offering includes the product.

5. A method according to claim 1, wherein the identifying comprises forming a data organization according to at least one of complimentary product options and limiting product options.

6. A method according to claim 5, wherein the forming a data organization comprises adding data references.

7. A method according to claim 5, wherein the data organization is a tree structure.

8. A method according to claim 1, wherein the rules comprise logical operators.

9. A method according to claim 3, wherein the generating comprises generating a product configurator for enabling a user to select from among product options of a product if the offering includes the product, and for selecting from among service options of a service if the offering includes the service.

10. A method according to claim 10, wherein the product options include package options and non-package options.

11. A method according to claim 10 wherein a user selection of a package option excludes a non-package option.

12. A method according to claim 1, wherein the generating generates an order entry system operable according to the rules.

13. A method according to claim 13, wherein the solution space further comprises a supply checking system for determining whether a product including selected options can be supplied.

14. A method according to claim 1, wherein the modeling models a constraint relationship of configuration information applicable to a configuration manager and one or more inter-entity systems implemented as a virtual agent network.

15. A system for modeling a constraint relationship, comprising:
means for receiving data;
means for identifying a solution space corresponding to the data;
means for setting rules for evaluating constraint relationships of the data and for navigating the solution space; and
means for generating cross-domain logical response engines corresponding to a navigation of the solution space.
